(19) United States
(12) Patent Application Publication
(10) Pub. No.: US 2015/0026086 A1
(43) Pub. Date: Jan. 22, 2015

(54) SYSTEMS AND METHODS FOR PROVIDING A VIRTUAL STAFFING AGENCY

(71) Applicant: TempDaddy, Inc., Boston, MA (US)

(72) Inventor: Alireza ADELI-NADJAFI, Boston, MA (US)

(21) Appl. No.: 14/320,240

(22) Filed: Jun. 30, 2014

Related U.S. Application Data
(60) Provisional application No. 61/862,479, filed on Aug. 5, 2013.
(60) Provisional application No. 61/840,535, filed on Jun. 28, 2013.

(51) Int. Cl. G06Q 10/10

(52) U.S. Cl. CPC G06Q 10/1053
USPC 705/321

(57) ABSTRACT

This disclosure provides systems and methods for providing a virtual staffing agency that enables a real-time intelligent job placement. The virtual staffing agency allows a client to create an assignment using its computing device and submit the assignment to a server. Subsequently, the client can receive, at its computing device from the server, a list of candidate personnel suitable for the assignment. In response, the client can select one or more candidate personnel from the list and wait for the selected candidate personnel to accept the assignment. The selected candidate personnel can accept, reject, or provide a counter offer to the assignment. Once the candidate personnel accept the assignment, a contract is formed and the personnel can perform the assignment, thereby allowing the client to fulfill job assignments in a real time, flexible, and intelligent manner.

### CROSS-REFERENCE TO RELATED APPLICATION

This application claims priority to U.S. Provisional Patent Application No. 61/862,479, entitled “SYSTEMS AND METHODS FOR PROVIDING A VIRTUAL STAFFING AGENCY,” filed on Aug. 5, 2013. This application also claims priority to U.S. Provisional Patent Application No. 61/840,535, entitled “SYSTEMS AND METHODS FOR PROVIDING A VIRTUAL STAFFING AGENCY,” filed on Jun. 28, 2013. Each of the above-identified provisional applications is hereby expressly incorporated by reference herein in its entirety.

### TECHNICAL FIELD

Disclosed systems and methods relate generally to providing a staffing agency, and specifically to providing a virtual staffing agency for placing temporary or permanent personnel with clients.

### BACKGROUND

Individuals seeking employment face unique challenges in searching for work. Personnel must find clients with job openings consistent with the particular skills they possess. Similarly, clients with job openings must find personnel whose skills provide a good match for their needs. In today's information age, both personnel and clients face increased competition for limited positions.

To assist in employing matching personnel and clients, a virtual staffing agency can facilitate a match between clients (e.g., a party that is seeking to hire a person or an entity for a job or an assignment) and/or personnel (e.g., a party that is seeking a job or an assignment.)

Several types of virtual staffing agencies have been proposed and used. However, existing virtual staffing agencies often do not provide an efficient, real time client/personnel match and job order fulfillment. Furthermore, oftentimes, the existing virtual staffing agencies do not allow clients to set their own price for the job or the assignment. In addition, the operating cost of the existing virtual staffing agencies is high, which increases the cost for clients and personnel to use services provided by the existing virtual staffing agencies. Moreover, the existing virtual staffing agencies lack a reliable mechanism for finding a good match and oftentimes, the existing virtual staffing agencies do not allow personnel to explore placements.

Therefore, there is a need to address the deficiencies associated with the existing virtual staffing agencies.

### SUMMARY OF DISCLOSURE

Virtual staffing agency systems and methods are presented. In some embodiments, a method for providing a virtual staffing agency comprises collecting attribute information via a first electronic device from at least one temporary personnel, wherein the attribute information is stored in a database on an application server, receiving, at the application server, a request for a temporary personnel for a temporary job placement from a client via a second electronic device, wherein the temporary job placement is associated with temporary job criteria, wherein the temporary job criteria is stored in the database on the server, generating, via a computer processor, a match between the temporary client and the at least one temporary personnel based on a comparison of the attribute information and the temporary job criteria stored in the database, and notifying, via the first electronic device, the temporary personnel of the match. In some embodiments, providing a virtual staffing agency includes receiving, via the computer processor, a notification of acceptance of the match from the temporary personnel, and notifying, via the second electronic device, the temporary client of the accepted match. In some embodiments, providing a virtual staffing agency includes receiving, at the application server, a notification of acceptance of the match from the temporary client, and notifying, via the first electronic device, the temporary personnel of the accepted match. In some embodiments, providing a virtual staffing agency includes notifying, via the first electronic device, the temporary personnel of a date, time, and location of a temporary job associated with the accepted match. In some embodiments, providing a virtual staffing agency includes generating, at the application server, a list of directions to a job site based on a current location of a matched personnel, and providing, via the first electronic device, the list of directions to the personnel. In some embodiments, providing a virtual staffing agency includes providing, via the first electronic device, a first code to a matched personnel to clock into the matched job, and receiving, at the application server, a notification of an input at a computer terminal of the first code by the personnel. In some embodiments, providing a virtual staffing agency includes providing, via the first electronic device, a second code to the matched personnel to clock out of the matched job. The attribute information can comprise job certification data, and the attribute information can comprise at least a desired payment rate, dates of availability, and a date of birth. The attribute information further can comprise a name, an email address, a home address, and a telephone number. The attribute information further can comprise a license type and an associated skill set. The temporary job criteria can comprise at least a distance preference, an employer name, and an employer address. In some embodiments, generating the match between the temporary client and the at least one temporary personnel further can comprise receiving, at the application server, a variance associated with the temporary job criteria, wherein the variance comprises a deviation from the temporary job criteria, and matching, via the computer processor, the temporary client and the at least one temporary personnel if the attribute information is within the variance provided by the client associated with the temporary job criteria.

In some embodiments, a computer system comprises a processor coupled to a computer readable storage media and executing computer readable code which causes the computer system to perform operations including collecting attribute information via a first electronic device from at least one temporary personnel, wherein the attribute information is stored in a database on an application server, receiving, at the application server, a request for a temporary personnel for a temporary job placement from a client via a second electronic device, wherein the temporary job placement is associated with temporary job criteria, wherein the temporary job criteria is stored in the database on the server, generating, via a computer processor, a match between the temporary client and the at least one temporary personnel based on a comparison of the attribute information and the temporary job criteria stored in the database, and notifying, via the first electronic device, the temporary personnel of the match. In some embodiments, providing a virtual staffing agency includes receiving, via the computer processor, a notification of acceptance of the match from the temporary personnel, and notifying, via the second electronic device, the temporary client of the accepted match. In some embodiments, providing a virtual staffing agency includes receiving, at the application server, a notification of acceptance of the match from the temporary client, and notifying, via the first electronic device, the temporary personnel of the accepted match. In some embodiments, providing a virtual staffing agency includes notifying, via the first electronic device, the temporary personnel of a date, time, and location of a temporary job associated with the accepted match. In some embodiments, providing a virtual staffing agency includes generating, at the application server, a list of directions to a job site based on a current location of a matched personnel, and providing, via the first electronic device, the list of directions to the personnel. In some embodiments, providing a virtual staffing agency includes providing, via the first electronic device, a first code to a matched personnel to clock into the matched job, and receiving, at the application server, a notification of an input at a computer terminal of the first code by the personnel. In some embodiments, providing a virtual staffing agency includes providing, via the first electronic device, a second code to the matched personnel to clock out of the matched job. In some embodiments, generating the match between the temporary client and the at least one temporary personnel further can comprise receiving, at the application server, a variance associated with the temporary job criteria, wherein the variance comprises a deviation from the temporary job criteria, and matching, via the computer processor, the temporary client and the at least one temporary personnel if the attribute information is within the variance provided by the client associated with the temporary job criteria.

In some embodiments, a computerized device for providing a virtual staffing agency has stored thereon computer executable instructions that, when executed by a computer system cause the computer system to perform a method comprising collecting, via a user interface, attribute information from at least one temporary personnel, sending, to an application server, a request for a temporary job placement, and receiving, from the application server, a notification of a match between the at least one temporary personnel and a temporary client based on a comparison of the attribute information and temporary job criteria stored in the database, wherein the temporary job placement is associated with temporary job criteria. In some embodiments, providing a virtual staffing agency includes sending, to the application server, a notification of acceptance of the match from the at least one temporary personnel, and notifying, via the user interface, the at least one temporary personnel of the accepted match. In some embodiments, providing a virtual staffing agency includes notifying, via the user interface, the at least one temporary personnel of a date, time, and location of a temporary job associated with the accepted match.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 illustrates a diagram of a networked communication system in accordance with an embodiment of the disclosed subject matter.

FIG. 2 illustrates a diagram of a matched users in accordance with an embodiment of the disclosed subject matter.

FIG. 3 shows a flow diagram of a process for interacting with a virtual agency system as a personnel in accordance with some embodiments of the disclosed subject matter.

FIG. 4 shows a flow diagram of a process for interacting with a virtual agency system as a personnel in accordance with some alternative embodiments of the disclosed subject matter.

FIG. 5 shows a flow diagram of a process for interacting with a virtual agency system as a client in accordance with some embodiments of the disclosed subject matter.

FIG. 6 shows a flow diagram of a process for interacting with a virtual agency system as a client in accordance with some alternative embodiments of the disclosed subject matter.

FIG. 7 shows a collection of information held by the server for a personnel in accordance with some embodiments of the disclosed subject matter.

FIG. 8 shows a collection of information used for matching a personnel with a client in accordance with some embodiments of the disclosed subject matter.

FIG. 9 shows criteria used to match clients with personnel in accordance with some embodiments of the disclosed subject matter.

FIGS. 10A and 10B show an example of a portion of the sign up process for a client on both a desktop and mobile browser.

FIGS. 11A and 11B show an another example of a portion of the sign up process for a client on both a desktop and mobile browser.

FIGS. 12A and 12B show an example of a portion of the sign up process for a personnel on both a desktop and mobile browser.

FIGS. 13A and 13B show an another example of a portion of the sign up process for a personnel on both a desktop and mobile browser.

FIGS. 14A and 14B show an another example of a portion of the sign up process for a personnel on both a desktop and mobile browser.

FIG. 15 shows an exemplary sample of a loading screen on a mobile web interface for logging into the system for a client in accordance with some embodiments of the disclosure.

FIG. 16 shows an exemplary sample of a preliminary login screen on a mobile web interface in accordance with some embodiments of the disclosure.

FIG. 17 shows an exemplary login screen on a mobile web interface in accordance with some embodiments of the disclosure.

FIGS. 18A and 18B show a sample of the desktop and mobile web interfaces for posting a job to the system for a client in accordance with some embodiments of the disclosure.

FIG. 19 shows a sample of the mobile interface for posting a job to the system for a client in accordance with some embodiments of the disclosure.

FIGS. 20A and 20B show a sample of the desktop and mobile web screens for viewing interested employees for a job in accordance with some embodiments of the disclosure.

FIGS. 21A and 21B show a sample of the desktop and mobile web screens for viewing the profile of an interested employee in accordance with some embodiments of the disclosure.

FIG. 22 provides an exemplary screen presented to a matched personnel in accordance with an embodiment of the disclosure.

FIG. 23 illustrates a main application page in accordance with some embodiments.

FIG. 24 illustrates an exemplary assignment generation page that allows a client to provide details of a new job assignment.

FIG. 25 illustrates potential options for the candidate personnel type provided to a client in response to a selection of a personnel type icon in accordance with some embodiments.

FIG. 26 illustrates an interface for selecting a date and time in accordance with some embodiments.

FIG. 27 illustrates an interface for selecting a location in accordance with some embodiments.

FIG. 28 illustrates an interface for selecting a rate in accordance with some embodiments.

FIG. 29 illustrates an interface that displays a selected candidate personnel in accordance with some embodiments.

FIG. 30 illustrates an interface notifying a match in accordance with some embodiments.

FIG. 31 illustrates an interface for requiring a personnel to provide a scan of a scannable code in accordance with some embodiments.

FIG. 32 illustrates a work ticket item receipt in accordance with some embodiments.

FIG. 33 illustrates an interface for notifying that no personnel has been found for an assignment in accordance with some embodiments.

FIG. 34 shows a flow diagram of a process experienced by a personnel in a virtual agency system in accordance with some embodiments of the disclosed subject matter.

FIG. 35 illustrates a notification of assignments in accordance with some embodiments.

FIG. 36 illustrates a notification appearing as a flag on an application icon in accordance with some embodiments.

FIG. 37 illustrates an interface showing available assignment(s) for a personnel's review in accordance with some embodiments.

FIG. 38 illustrates personnel selecting a name and location of an assignment with an associated map in accordance with some embodiments.

FIG. 39 illustrates personnel selecting a date and time of an assignment in accordance with some embodiments.

FIG. 40 illustrates personnel selecting an estimated travel time icon so that a personnel may adjust an arrival time to be communicated to a client in accordance with some embodiments.

FIG. 41 illustrates an interface for indicating that a personnel has been selected for an assignment in accordance with some embodiments.

FIG. 42 illustrates a client requiring a personnel to obtain a text code to enter into an application in order to confirm work commencement in accordance with some embodiments.

FIG. 43 illustrates an interface that notifying a personnel that the personnel was not selected for an assignment in accordance with some embodiments.

FIG. 44 illustrates a set of options supported by an application operating in a virtual staffing agency in accordance with some embodiments.

### DETAILED DESCRIPTION

In the following description, numerous specific details are set forth regarding the systems and methods of the disclosed subject matter and the environment in which such systems and methods can operate, etc., in order to provide a thorough understanding of the disclosed subject matter. It will be apparent to one skilled in the art, however, that the disclosed subject matter can be practiced without such specific details, and that certain features, which are well known in the art, are not described in detail in order to avoid complication of the subject matter of the disclosed subject matter. In addition, it will be understood that the examples provided below are exemplary, and that it is contemplated that there are other systems and methods that are within the scope of the disclosed subject matter.

The disclosed systems and methods can provide a virtual staffing agency for connecting personnel with clients. In particular, embodiments of the disclosed subject matter provides a temporary or permanent labor matching service that can align a client's request with a personnel's offering. Disclosed systems can significantly reduce traditional overhead in matching personnel with clients.

Clients can use the system to create a profile and to update requests that create a record of the type of resource and the availability. The availability could be immediate, and the system would offer up resource choices, or the system could work asymmetrically, alerting the employer later if a match (or matches) is found. Once the client has chosen a personnel, based upon criteria such as cost, distance, skill level, job history, ratings, etc., the system engages the personnel via multiple methods. Once the personnel (employee) accepts, they alert the system with a confirmation, and the system alerts the client of the personnel's acceptance, status, and contact information. Using a unique pin and various fall back methods if needed, the personnel can check-in for their assignment and check-out when complete.

Personnel can use the system to accept the offer based upon criteria such as immediacy, rate, distance, etc. The system can provide personnel with directions and contact information of their contact once on-site. After they complete their assignment, and complete the check-in and check-out process, personnel are given a summary of the work performed via a supported method of their choosing.

In some embodiments, the disclosed systems and methods further allow clients to set their own price for a job or an assignment. This way, the clients can obtain better control over the job or the assignment, in particular, the cost of hiring a person for the job or the assignment. In some embodiments, the virtual staffing agency can be implemented on a cloud-based system, reducing a service fee associated with using the disclosed systems and methods relative to other solutions. This low service fee can allow clients to use the virtual staffing agency more frequently and integrate the virtual staffing agency in their business plans for providing a cost-effective staffing solution. In addition, the disclosed virtual staffing agency can provide a good match between the clients and personnel based on information about the clients and personnel, such as preferences of the clients and personnel as well as location information associated with the clients and personnel. Furthermore, the disclosed virtual staffing agency can provide a good testing mechanism for clients and/or temporary personnel to explore the most effective placement and suitability since clients can, for example, use the disclosed virtual staffing agency to determine the capability of temporary personnel and determine whether to hire the temporary personnel full-time.

In some embodiments, the virtual staffing agency can further be configured to enable a real-time intelligent job placement based on client's and personnel's preferences. As described above, a client can include a person or entity that is looking to hire a person for a job or an assignment, and a personnel can include one or more persons that are looking for a job or an assignment. A client can use an application to create an assignment. The assignment can include information on, among other things, (1) a type of work (e.g., attending a mailroom), (2) a time period of employment (e.g., today from 9 AM-5 PM), (3) a location of work place, and/or (4) an amount of fee to be paid either upon completion of work or periodically.

Once the client creates the assignment, the application can submit the assignment to a server. Based on the assignment, the server can identify one or more candidate personnel. For example, the server can select the candidate personnel based on the geographic proximity of candidate personnel to the work place. In another example, the server can select the candidate personnel based on a rating associated with candidate personnel. In yet another example, the server can select the candidate personnel based on candidate personnel's status. For instance, the server can maintain a database that indicates that a particular candidate is scheduled to perform another assignment during the time period of employment indicated in the assignment. The server can use that database to screen candidates that cannot perform the work indicated in the assignment.

Upon selecting the candidate personnel, the server can provide a list of the selected candidate personnel to the client. In some cases, the list of one or more selected candidate personnel can indicate information about the one or more selected personnel. The client can review the list of candidate personnel and select, from the list, a potential personnel for the assignment. In some cases, the client can select one potential personnel from the list. In other cases, the client can select several candidate personnel from the list. Subsequently, the client can send the selection of candidates to the server.

Subsequently, the server can send a notification to the selected potential personnel. The notification can include a push notification that appears on a screen of a mobile device. The selected potential personnel can then review the assignment and can perform one of the following: (1) accept the assignment, (2) reject the assignment, and (3) provide a counter offer.

If a potential personnel accepts the assignment, the server notifies both the client and the potential personnel that the match has occurred and that they proceed to perform the work. If multiple potential personnel accept the assignment, the server can, for example, either (1) allow the client to select one of the multiple candidates for the assignment or (2) create a match for the first-responding potential personnel and reject the remaining potential personnel. If a potential personnel provides a counter offer, then the server can mediate a negotiation process so that the client and the potential personnel can agree on the terms of employment.

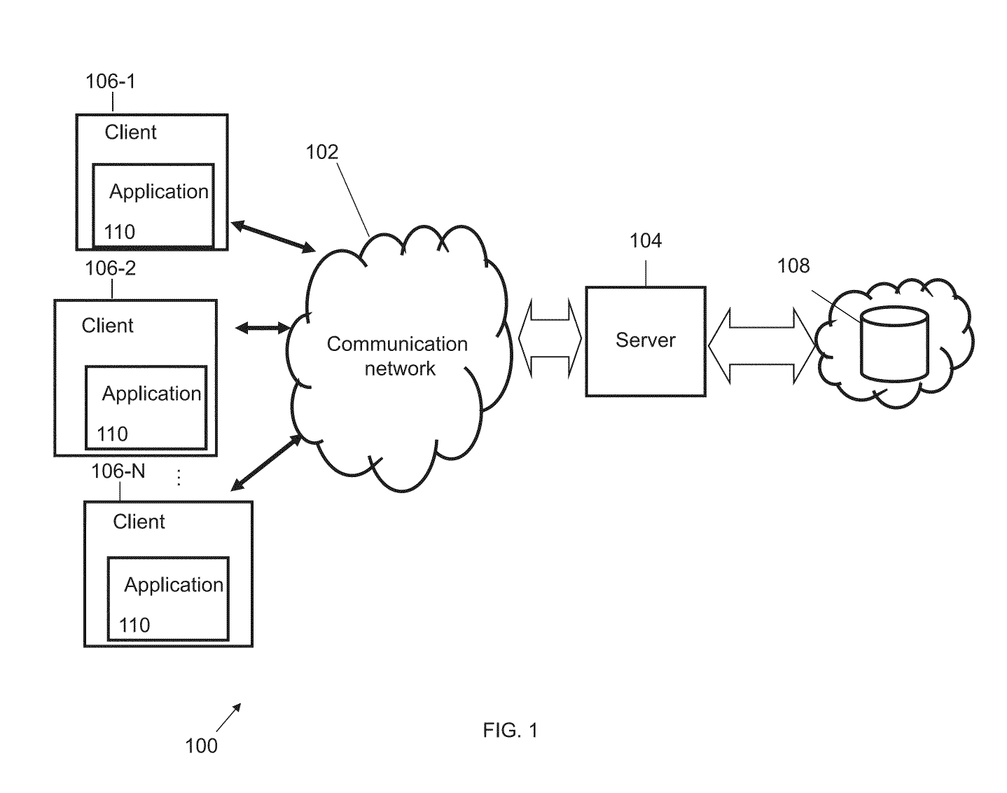

FIG. 1 illustrates a diagram of a networked communication arrangement in accordance with an embodiment of the disclosed subject matter. The networked communication arrangement 100 can include, for example, a communication network 102, a server 104, and at least one computing device 106 (e.g., computing device 106-1, 106-2, . . . 106-N), a storage device 108, and application 110.

The communication network 102 can include a network or combination of networks that can accommodate private data communication. For example, the communication network 102 can include a cellular network, including a universal mobile telecommunications systems (UMTS) network, a Long Term Evolution (LTE) network, or a Global System for Mobile Communications (GSM) network. As another example, the communication network 102 can include a local area network (LAN), a virtual private network (VPN) coupled to the LAN, a private cellular network, a private telephone network, a private computer network, a private packet switching network, a private line switching network, a private wide area network (WAN), a corporate network, or any number of private networks that can be referred to as an Intranet. Such networks can be implemented with any number of hardware and software components, transmission media and network protocols. FIG. 1 shows the network 102 as a single network; however, the network 102 can include multiple interconnected networks listed above.

Each computing device 106 can send data to, and receive data from, the server 104 over the communication network 102. Each computing device 106 can be directly coupled to the server 104; alternatively, each computing device 106 can be connected to server 104 via any other suitable device, communication network, or combination thereof. For example, each computing device 106 can be coupled to the server 104 via one or more routers, switches, access points, and/or communication networks (as described below in connection with communication network 102).

In some embodiments, a computing device 106 can operate a software application 110 for creating an assignment. For example, a client can create a work assignment using a software application 110 running on a computing device 106. A computing device 106 can also operate a software application 110 for receiving an assignment. For example, a candidate personnel can receive a work assignment using a software application 110 running on a computing device 106. In some cases, the software application 110 for creating an assignment and receiving an assignment can be an identical software application 110. The software application 110 can be stored in memory. The memory can be a non-transitory computer readable medium, flash memory, a magnetic disk drive, an optical drive, a programmable read-only memory (PROM), a read-only memory (ROM), or any other memory or combination of memories. The software can run on a processor capable of executing computer instructions or computer code. The processor might also be implemented in hardware using an application specific integrated circuit (ASIC), programmable logic array (PLA), field programmable gate array (FPGA), or any other integrated circuit.

A computing device 106 can include any computing device that is capable of performing computation and is also capable of providing location information. The location information can include a Global Positioning System (GPS) coordinate or a latitude/longitude coordinate. The computing device 106 can include a desktop computer, a mobile computer, or a tablet computer. The computing device 106 can also include a cellular device, including user equipment. The user equipment communicates with one or more radio access networks and/or with wired communication networks. The user equipment can be a cellular phone having phonetic communication capabilities. The user equipment can also be a smart phone providing services such as word processing, web browsing, gaming, e-book capabilities, an operating system, and a full keyboard. The user equipment can also be a tablet computer providing network access and most of the services provided by a smart phone. The user equipment operates using an operating system such as Symbian OS, iPhone OS, RIM's Blackberry, Windows Mobile, Linux, HP WebOS, and Android. The screen might be a touch screen that is used to input data to the mobile device, in which case the screen can be used instead of the full keyboard. The user equipment can also keep global positioning coordinates, profile information, or other location information.

The computing device 106 also includes any platforms capable of computations and communication. Non-limiting examples can include televisions (TVs), video projectors, set-top boxes or set-top units, digital video recorders (DVR), computers, netbooks, laptops, and any other audio/visual equipment with computation capabilities. The computing device 106 is configured with one or more processors that process instructions and run software that can be stored in memory. The processor also communicates with the memory and interfaces to communicate with other devices. The processor can be any applicable processor such as a system-on-a-chip that combines a CPU, an application processor, and flash memory. The computing device 106 can also provide a variety of user interfaces such as a keyboard, a touch screen, a trackball, a touch pad, and/or a mouse. The computing device 106 can also include speakers and a display device in some embodiments.

The server 104 can intermediate communication between clients and personnel operating computing devices 106. The server 104 can operate using an operating system (OS) software. In some embodiments, the OS software is based on a Linux software kernel and runs specific applications in the server such as monitoring tasks and providing protocol stacks. The OS software can allow server resources to be allocated separately for control and data paths. For example, certain packet accelerator cards and packet services cards can be dedicated to performing routing or security control functions, while other packet accelerator cards/packet services cards can be dedicated to processing user session traffic. As network requirements change, hardware resources can be dynamically deployed to meet the requirements in some embodiments.

The server's software can be divided into a series of tasks that perform specific functions. These tasks communicate with each other as needed to share control and data information throughout the server 104. A task can be a software process that performs a specific function related to system control or session processing. Three types of tasks operate within the server 104 in some embodiments: critical tasks, controller tasks, and manager tasks. The critical tasks control functions that relate to the server's ability to process calls such as server initialization, error detection, and recovery tasks. The controller tasks can mask the distributed nature of the software from the user and perform tasks such as monitoring the state of subordinate manager(s), providing for intra-manager communication within the same subsystem, and enabling inter-subsystem communication by communicating with controller(s) belonging to other subsystems. The manager tasks can control system resources and maintain logical mappings between system resources.

Individual tasks that run on processors in the application cards can be divided into subsystems. A subsystem is a software element that either performs a specific task or is a culmination of multiple other tasks. A single subsystem can include critical tasks, controller tasks, and manager tasks. Some of the subsystems that run on the server 104 include a system initiation task subsystem, a high availability task subsystem, a shared configuration task subsystem, and a resource management subsystem.

The system initiation task subsystem can be responsible for starting a set of initial tasks at system startup and providing individual tasks as needed. The high availability task subsystem works in conjunction with the recovery control task subsystem to maintain the operational state of the server 104 by monitoring the various software and hardware components of the server 104. The recovery control task subsystem can be responsible for executing a recovery action for failures that occur in the server 104 and receives recovery actions from the high availability task subsystem. Processing tasks can be distributed into multiple instances running in parallel so that if an unrecoverable software fault occurs, the entire processing capabilities for that task are not lost. User session processes can be sub-grouped into collections of sessions so that if a problem is encountered in one sub-group users in another sub-group will not be affected by that problem.

The shared configuration task subsystem can provide the server 104 with an ability to set, retrieve, and receive notification of server configuration parameter changes and is responsible for storing configuration data for the applications running within the server 104. The resource management subsystem can be responsible for assigning resources (e.g., processor and memory capabilities) to tasks and for monitoring the task's use of the resources.

In some embodiments, the server 104 can reside in a data center and form a node in a cloud computing infrastructure. The server 104 can also provide services on demand. A module hosting a computing device is capable of migrating from one server to another server seamlessly, without causing program faults or system breakdown. The server 104 on the cloud can be managed using a management system.

In some embodiments, the server 104 can maintain information about clients, personnel, and/or the staffing agency operating the virtual staffing agency system. The information in the server 104 can be configured or accessed using a website. The website can include three sections: the first section for the client's use, the second section for the personnel's use, and the third section for the staffing agency's use.

The first section of the website can provide the client with a variety of options and functionalities once the client creates a username and a password. For example, the website allows the client to: (1) provide a response to the facility questionnaire for providing information about the facilities or the work place operated by the client, (2) provide information on the desired skill set of personnel that the client is looking for, (3) provide state and federal licensing information, (4) provide images of the client's practice, (5) review and sign the staffing agency agreement, (6) review and sign the fee structure for using the virtual staffing agency and/or for the assignments, (7) review and sign the payment agreement, and provide checking and/or routing number securely to set up automatic fund withdrawal from the bank account of their choosing, (8) review frequently asked questions (FAQ), (9) review information on a referral program, (10) access social media associated with the virtual staffing agency, (11) review historic staffing information, which can include the year-to-date expenditure for hiring temporary or permanent personnel, (12) request a personnel for a particular type of assignment so that the particular type of assignment can be assigned to the same personnel repeatedly, (13) access an educational video that provides information on how the website and the mobile application work in conjunction with the other, and (14) access email or social media to contact the regional manager of the virtual staffing agency for questions/concerns or recommendations about the virtual staffing agency.

The second section of the website can provide the personnel with a variety of options and functionalities once the personnel creates a username and a password. For example, the website allows the personnel to: (1) provide information on personnel's skill level and experience, (2) provide availability information of the personnel, indicating, for example, personnel's temporal and geographical availabilities, where the temporal availabilities can be indicated using the personnel's schedule or travel plans (e.g., I am available on Mondays from 8 AM-5 PM); and the geographical availabilities can be indicated as personnel's geographic preferences (e.g., I am willing to travel a radius of 5 miles from my house and I have a car at my disposal and parking is not an issue,) (3) provide state and federal licensing information, (4) provide a professional image of the personnel, (5) review and sign the staffing agency agreement, (6) review and sign the fee structure for using the virtual staffing agency and/or for the assignments, (7) review and sign the payroll agreement and enter checking and routing number securely to set up a direct deposit, (8) review information on a referral program, (9) access social media associated with the virtual staffing agency, (10) review historic staffing information, which can include the year-to-date earnings from working as a personnel through the virtual staffing agency, (11) verify the work eligibility electronically, for example, by providing 19 information to verify the work eligibility in the United States, (12) access an educational video that provides information on how the website and the mobile application work in conjunction with the other, (13) access email or social media to contact the regional manager of the virtual staffing agency for questions/concerns or recommendations about the virtual staffing agency, (14) provide an electronic agreement to a background check, (15) provide current medical records, for example, a recent vaccination record indicating that the personnel complied with the Health Insurance Portability and Accountability Act (HIPPA) guidelines, (16) access an online testing site to take an industry related skill test and include the test core in a virtual resume associated with the personnel, (17) access an online education class, course, or webinars, and (18) review and sign the rule and code of conducts of the best staffing practices.

The third section of the website can allow an administrator of the virtual staffing agency to review and monitor information associated with the clients and personnel, and to manage the information virtually to the extent possible. For example, the third section of the website can allow the administrator to compile: (1) financial and earning reports of the staffing agency, (2) staff information about the staffing agency, including a number of staff, a geographic distribution of staff in relation to a geographic distribution of clients in various regions, (3) wage information on a real time average hourly salary that are being offered in each industry and it's subcategories (for example, in the dental field, the current average dental assistant hourly rate in Boston is 20 dollars per hours,) and (4) payroll reports. The third section of the website can also allow the administrator to: (1) provide integration modules with partners, such as testing centers, payroll companies, etc., (2) review feedback from the clients and personnel via social media and respond to the feedback, (3) provide tailored, scalable, applicable, and functional services to all services industries, (4) recognize and match proper personnel with clients, (5) compute the distance and travel time between the current location of the candidate personnel and the work site based on the location information received from the interested personnel's mobile device and, optionally, the location information received from the client's mobile device, and (6) compute the total payment for an assignment and provide a payroll report to both the client and the personnel via, for example, an email.

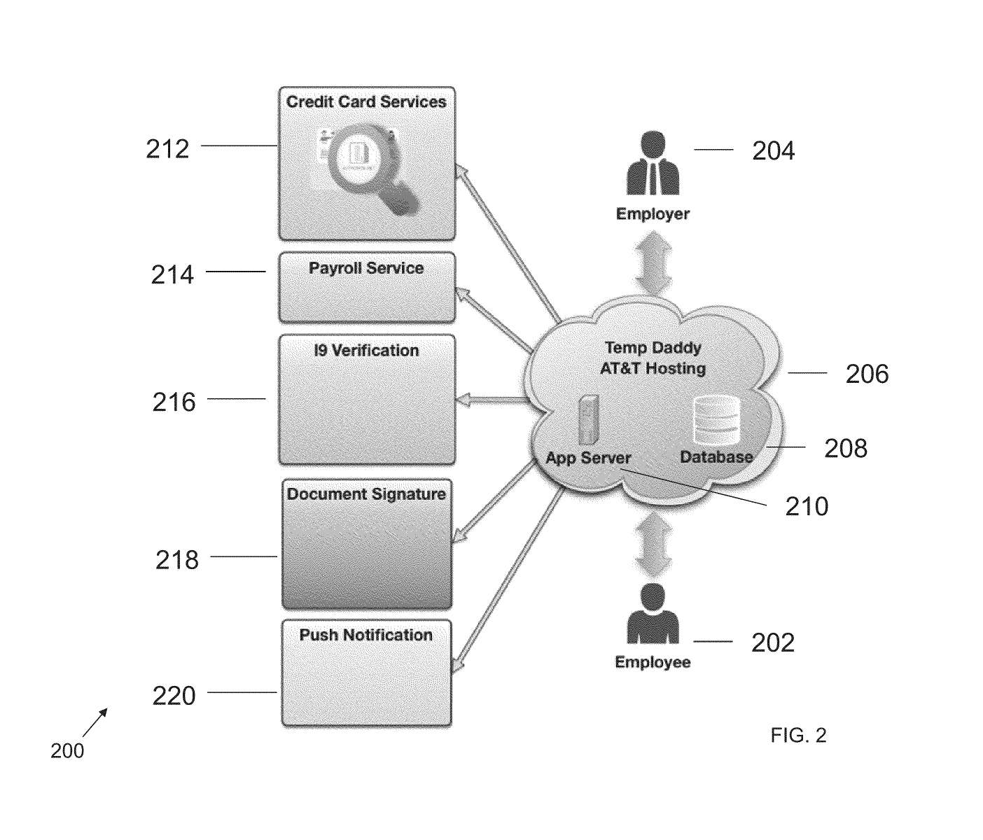

FIG. 2 illustrates an alternative networked communication arrangement connecting personnel and clients in accordance with an embodiment of the disclosed subject matter. The networked communication arrangement 200 can include personnel 202, client 204, a communication network 206, a database 208, a server 210, and external services 212, 214, 216, 218, and 220. Client 202, personnel 204, and external services 212, 214, 216, 218, and 220 can be connected via communication network 206 to database 208 resident on server 210.

In some embodiments, external service 212 can be a credit card authorization service such as Authorize.net® payment processing. External service 214 can be an Automated Clearing House (ACH) provider service, such as PAYCHEX®. External service 216 can be an immigration status verification service, such as the United States Department of Homeland Security E-Verify service. External service 218 can be digital document signature authentication service, such as DocuSign®. External service 220 can be a push notification service, such as UrbanAirship®. Each of these services are commercially available and known.

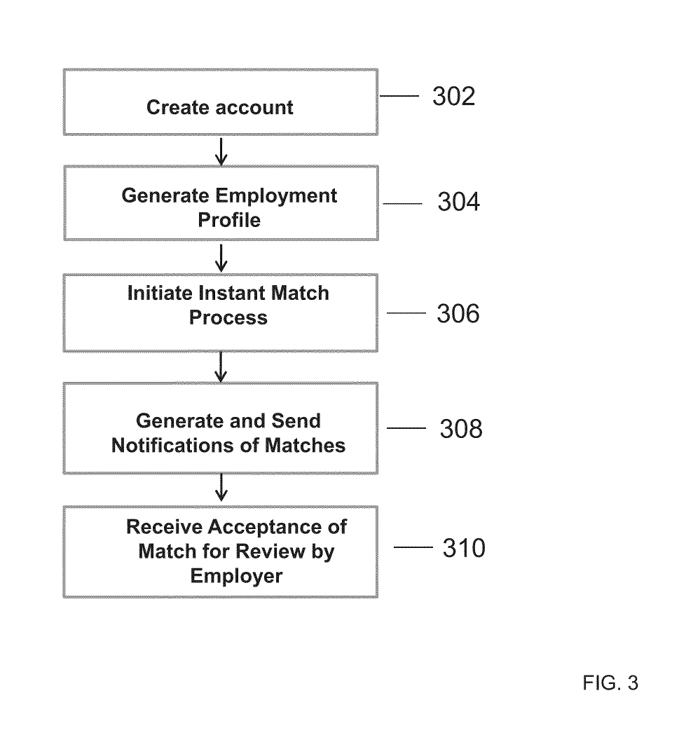

FIG. 3 shows a simplified flow diagram of a process experienced by a new personnel in a virtual agency system in accordance with some embodiments of the disclosed subject matter. FIG. 3 contains stages 302-312. One or more of stages 302-312 can be executed by a computerized module within server 104, by one or more clients 106, or by a combination of the preceding, as indicated below.

At stage 302, the personnel can use a computing device 106 to create an account with the virtual agency system. In some embodiments, the personnel can create an account by choosing a login name and password. In another embodiment, the personnel can use a social media account, such as a Facebook® account to generate a new account with the virtual agency system. In some embodiments, stage 302 can be executed by an account creation module within server 104.

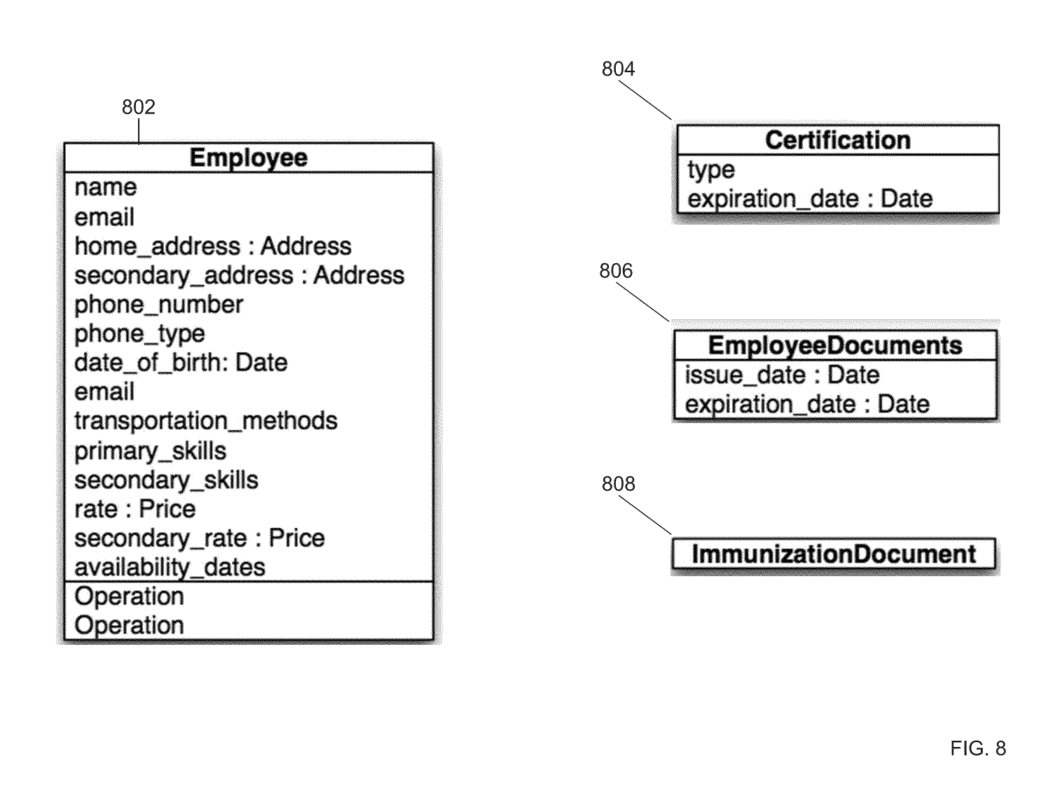

At stage 304, the personnel can generate an employment profile and submit the assignment to the server. In this stage, the personnel can provide attribute information to associate with a personnel profile. For example, in this stage, the personnel can specify information on, among other things, (1) a list of skills possessed by the personnel (e.g., experience with particular computer systems), (2) a list of certifications or licenses possessed by the personnel (e.g., a dental or law license, or a verified immigration status of the personnel), (3) a time period for employment availability (e.g., Monday through Friday of the current week from 7 AM-7 PM), (4) a home location, (5) an desired rate to be paid for work, (6) a phone number associated with the personnel, and (7) a background check status of the personnel. Other attribute information can be provided by the personnel, as identified in the descriptions of FIGS.1 and 8. In some embodiments, some of the information is automatically filled out on behalf of the personnel by using a linked Facebook.com® account. In some embodiments, stage 304 can be executed by a profile generation module within server 104.

The server 104 in communication with the client via the computing device 106 can subsequently determine several candidate personnel for the client and send the list of candidate personnel to the client. In some embodiments, the list of candidate personnel can include resumes. In some cases, the resumes can indicate the hourly rate requested by the candidate personnel.

In some embodiments, the personnel can be referred to the virtual employment agency by another individual associated with the agency. In this embodiment, the personnel can provide a referral code at the time of account creation to receive a promotional benefit. In one exemplary implementation, the referral code can be a five digit alphanumeric sequence.

In some embodiments, the phone number can further comprise a mobile phone number. In this embodiment, the personnel can additionally sign up for Short Message Service (SMS) notifications from the virtual agency system. The mobile number provided by the personnel can be verified by sending a short verification code to the mobile number. The personnel can then enter the verification code at the terminal to complete the mobile phone verification process. In one exemplary implementation, the verification code can be a four digit numeric code.

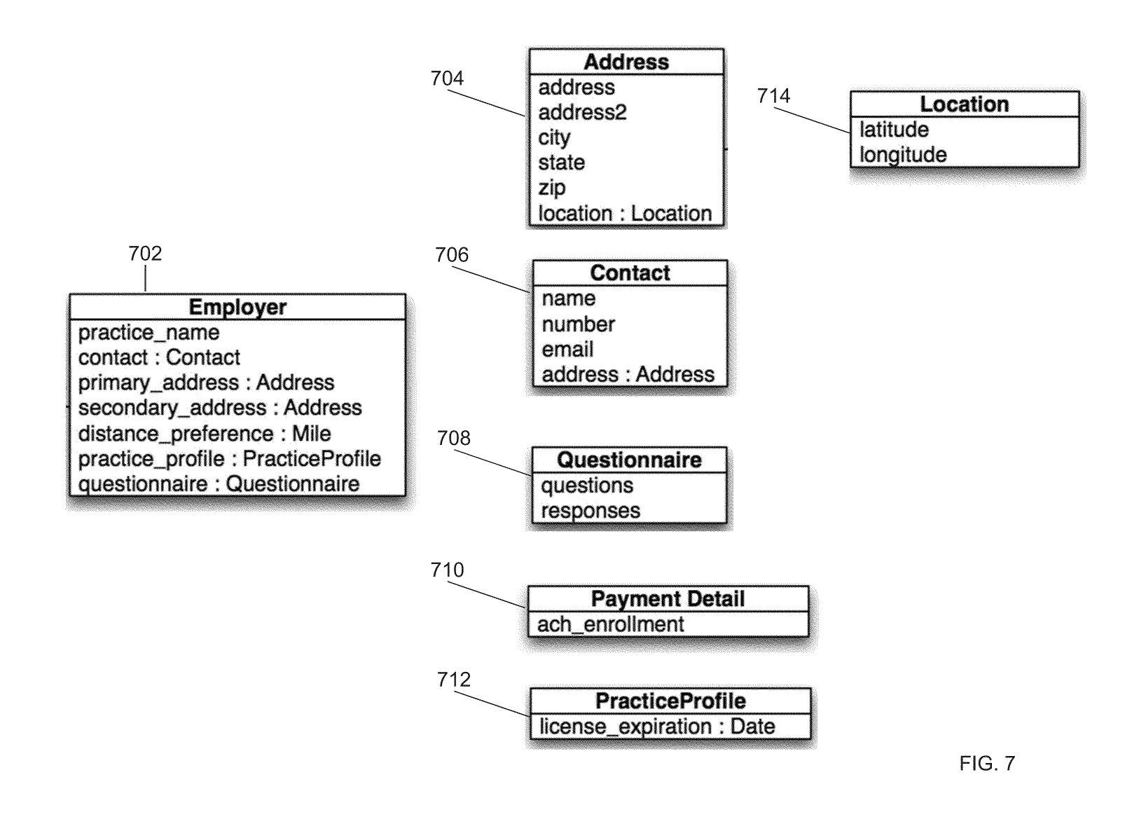

At stage 306, the server 104 can initiate an instant match process. The instant match process is a process used by the system to match personnel with clients based on particular personnel attribute information and client job criteria. A list of attributes and criteria used for matching personnel with clients is presented in more detail in FIGS. 7-9. In some embodiments, the instant match process can be configured to generate matches only when a minimum number of job criteria are satisfied by a personnel's attribute information. For example, the instant match process can be configured to generate a match only if at least five out of seven job criteria provided by the client are satisfied by the personnel. In some embodiments, stage 306 can be executed by a match generation module within server 104.

In another embodiment, the process can be configured to permit matches to be generated even if a minimum number of job criteria are not precisely satisfied. In this embodiment, job criteria can be considered to be satisfied by a personnel's attribute information if the attribute information is within a tolerance, known as a “variance” of the job criteria. In some embodiments, this criteria can be percentage based, for example, 10%. In one exemplary implementation, a client can seek personnel willing to work for $10 per hour or less. In this implementation, a personnel providing attribute information indicating a desired hourly rate of at least $11/hour can nevertheless be matched with the client, since the hourly rate is within the variance specified by the personnel. Other job criteria can be assigned a variance by the client, including, for example, skill set possessed (e.g., the employee does not possess a minimum number of requested skills), time period for availability (e.g., the requested start time is outside the client's provided availability period), and current location of the personnel (e.g., the personnel's current location is outside the maximum range requested by the client).

In another alternative embodiment, the personnel can browse a listing of jobs posted and made available for viewing by personnel. While searching the listing of available jobs, the personnel can view details of each posted job, including (1) the name of the user who posted the job, (2) the date of the posting, (3) the type of license, if any, required for the position, (4) the days and times where the work will be performed, (5) the offered hourly rate, (6) the skills required for the job, (7) the number of personnel already matched by the system for the particular job, and (8) the number of personnel who have expressed interest in the position. In this embodiment, the personnel can send an application directly to the client for a particular position.

At stage 308, the server 104 can generate an instant match and can notify the personnel that a match has been located. The instant match can be generated based on a comparison of the job criteria provided by the client and the attributes provided by the personnel. As described above, a match can be generated when a certain number of attributes of a personnel match the job criteria provided by the client. In another embodiment, a match can be generated when a certain number of attributes of a personnel are within a variance of the job criteria provided by the client. At this stage, multiple matches can be generated for a single position. In this scenario, all personnel matching the client's criteria are notified of the match. In some embodiments, stage 308 can be executed by a match notification module within server 104. In some embodiments, a match notification module on client 106 may query or poll server 106 for matches and may notify the personnel that a match has been made.

Once a personnel is matched with a client, the personnel can be notified of the match via an communication method set up with the virtual staffing agency. In some embodiments, the notification can comprise a push type notification to a client device, e.g., any client device 102(1)-102(N), to instantly notify a personnel of a match. In one exemplary implementation, the push notification can be an SMS message sent to a smartphone. In another implementation, the notification can be an email to the personnel. In another embodiment, a client device can poll for a notification.

At stage 310, the personnel can accept or reject the instant match. In some embodiments, accepting the instant match indicates that the personnel is ready to work for the client based on the terms provided in the instant match notification. Upon accepting the instant match, a client device 102 associated with the personnel can send a notification of acceptance to server 104. In another embodiment, the personnel can retain interest in the offer but decide, for example, the it does not provide sufficient compensation. In this embodiment, the personnel can provide a counter-offer to the client. In this embodiment, the personnel can receive notification of acceptance or rejection of the counter-offer by the client from server 104. In some embodiments, stage 310 can be executed by a personnel correspondence module within server 104. In some embodiments, a personnel correspondence module on a client 106 may perform one or more steps of stage 310.

In some embodiments, once a personnel accepts an offer or provides a counter-offer, the personnel has committed to working on the terms specified in the offer or counter-offer. At this point, the personnel must wait to receive notification of the client's final decision on whether to hire the personnel. If the client elects to hire the personnel, instructions will be sent to the client's client device 102 regarding the position. In some embodiments, the virtual staffing agency can provide directions from the personnel's current location to the client's location. If the client elects not to hire the personnel, the personnel can be notified that the position has been filled and can wait for another match notification. In another embodiment, the personnel can cancel the job engagement up until the start time for the matched job.

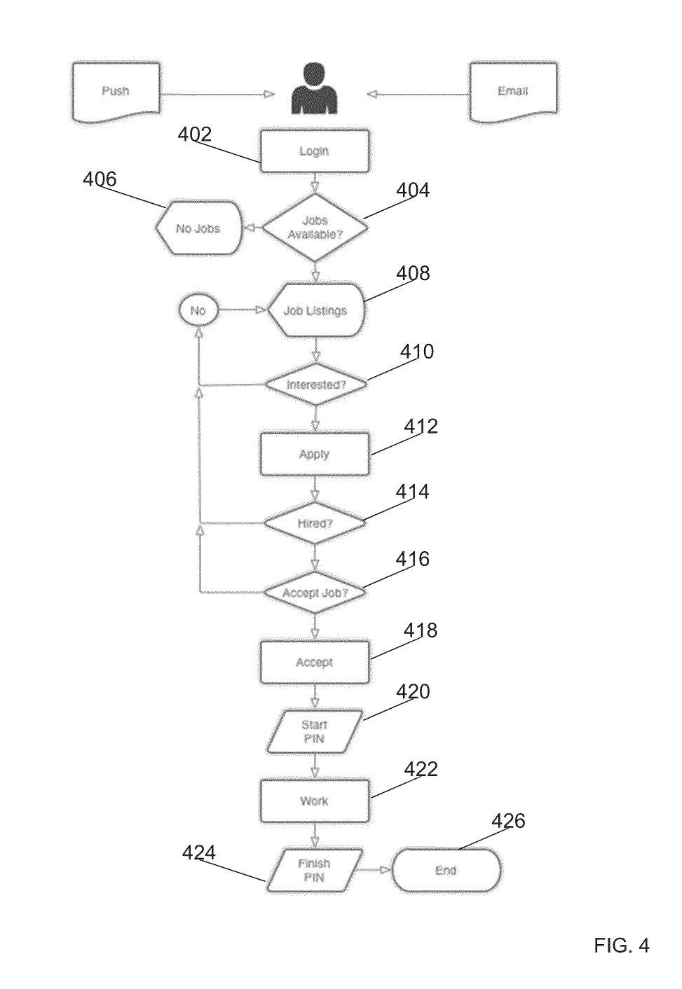

FIG. 4 shows a detailed flow diagram of a process experienced by a returning personnel in a virtual agency system in accordance with some embodiments of the disclosed subject matter. FIG. 4 contains stages 402-426.

At stage 402, the personnel can use a computing device 106 to login to the system with a previously created account. The personnel can login to the system at any time. In some embodiments, the personnel can login after receiving an e-mail indicating a potential job placement is available. In another embodiment, the personnel can login in response to a push notification sent to the personnel's client device 106. For a returning personnel, previously defined attributes, such as the attributes discussed at stage 304, can automatically be provided. For example, a preferred job type or payment rate can be automatically defined based on the personnel's previous preferences. In addition to the information provided during an initial setup at stage 304, returning personnel can possess a rating. The rating can be a discriminating system defined by a personnel's previous employers based on the personnel's previous performance. In some embodiments, the rating can be a number of stars from one to seven.

At this stage, if a personnel has successfully referred a new personnel to become a user of the system, the personnel's account can reflect a promotional credit awarded as a result of the referral.

At stage 404, the personnel can use the system to check if any matching jobs are available. If no matching jobs are available, the process proceeds to stage 406 and ends. If at least one job is available, the process proceeds to stage 408.

In some embodiments, the personnel can already be assigned to a job through the system. In this embodiment, the personnel cannot be matched for jobs requiring availability during the time allotted for the job already assigned to the personnel. The personnel can be matched for additional jobs that do not conflict with the required availability for the previously accepted job.

At stage 408, one or more available jobs matching the personnel's attributes are presented in a job listing. At this stage, the personnel can scroll through one or more available job listings and review job placement criteria associated with the job listings.

At stage 410, the personnel decides whether he has interest in a particular available job listings. If the personnel indicates he is not interested in a particular listing, the process proceeds back to stage 408 and the personnel is permitted to select a different job opportunity. If the personnel indicates interest in a particular opportunity, the process proceeds to stage 412.

At stage 412, the personnel submits an application to a client associated with a selected job posting.

At stage 414, the personnel is notified whether the client has chosen to hire the personnel. If the client does not hire the personnel, the process proceeds back to stage 408 and the personnel is permitted to select a different job opportunity. If the personnel is hired by the client, the process proceeds to stage 416.

At stage 416, the personnel chooses whether to accept the job opportunity for which he has been hired. If the client does not choose to accept the job opportunity, the process proceeds back to stage 408 and the personnel is provided an opportunity to select a different job opportunity. If the personnel chooses to accept the job opportunity, the process proceeds to stage 418 where the personnel submits his acceptance to the system. In some alternative embodiments, stages 416 and 418 are skipped, and stage 414 can proceed directly to stage 420 upon receipt of an acceptance by the client.

Upon receiving an acceptance from the personnel, the virtual staffing agency system can provide the personnel directions to the matched client's location based on the current location of the personnel. In some embodiments, these directions can be provided by a linked mapping application. For example, the directions can be provided by inputting the client's address into the Google Maps® application on the personnel's client device 106. The system can further indicate to the personnel the amount of time required to travel from a current location to the matched client's location. Based on this travel time, the system can further provide both the matched personnel and the matched client with an estimated time of arrival of the personnel.

In some embodiments, the system can provide a matched personnel the option to call or text a matched client for more information about the matched job. In this embodiment, the system can seamlessly facilitate communication between matched users of the system to ensure any remaining questions or issues regarding the match can be resolved.

At stage 420, the system provides the hired personnel with a first specialized code to present at the client's location to indicate arrival for work. In some embodiments, the specialized code can be, for example, a series of numbers that the hired personnel can enter at a computer terminal at a client's location. In another embodiment, the specialized code can be in image containing a number in a scannable format. In one implementation, the code can be a bar code that can be scanned by a standard bar code scanner. In another implementation, the code can be a QR code readable by the camera of a smartphone. This code can be provided to the personnel by SMS notification, by email, or directly when the personnel logs into the web or mobile interface.

At stage 422, the hired personnel begins his work for the day.

At stage 424, the hired personnel is provided a second specialized code to present to the client to indicate departure from work. This second specialized code can generally be in the same format as the first specialized code, although this is not required. The second specialized code can end the running “clock” associated with a personnel, triggering a payment authorization process. In some embodiments, presentation of the second specialized code can cause an immediate transfer of funds from the client to the personnel. Both the client and the personnel can be provided with an email receipt of the transaction. After the personnel provides the specialized code to the client, the process ends at stage 426.

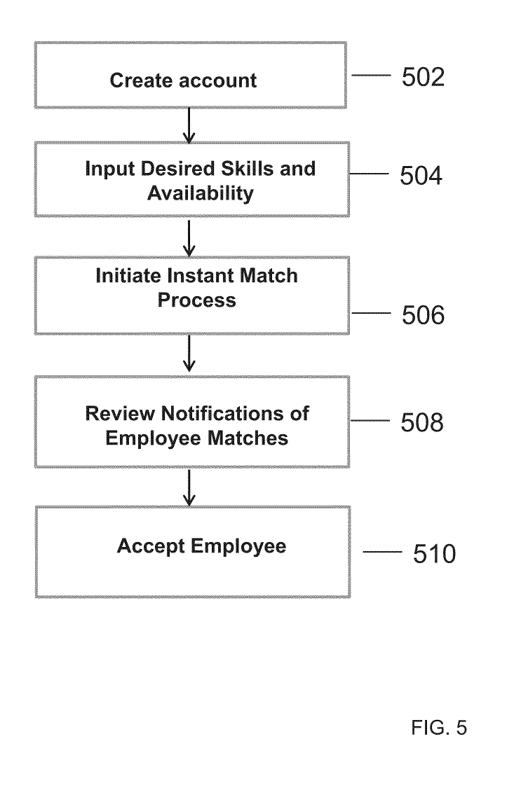

FIG. 5 shows a simplified flow diagram of a process experienced by a new client in a virtual agency system in accordance with some embodiments of the disclosed subject matter. FIG. 5 contains stages 502-510. One or more of stages 502-512 can be executed by a computerized module within server 104, by one or more clients 106, or by a combination of the preceding, as indicated below.

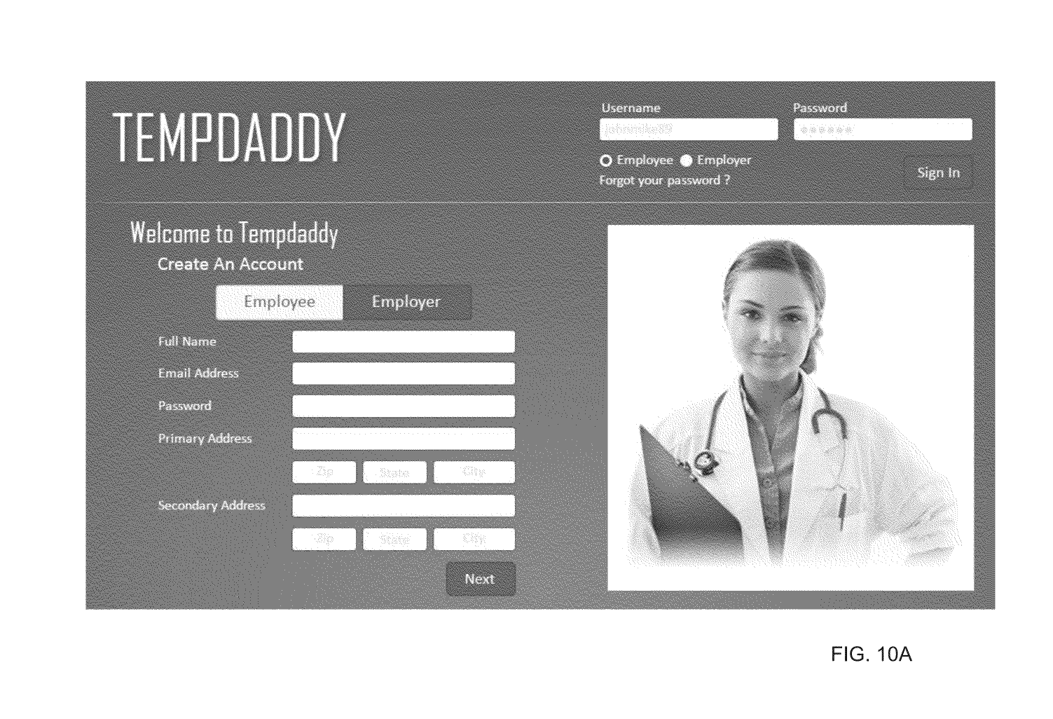

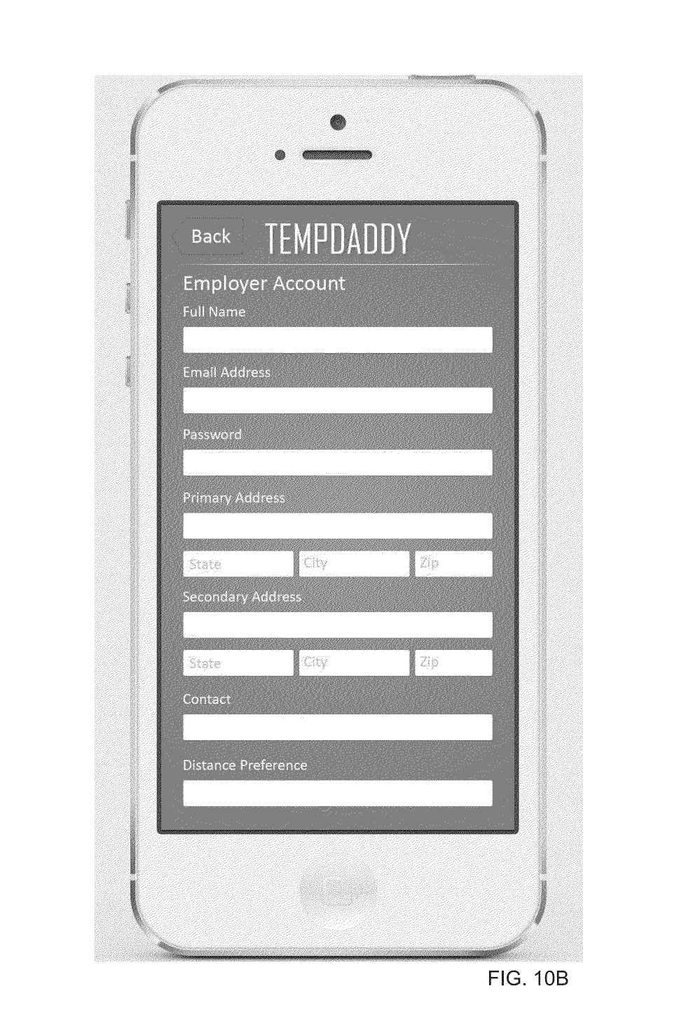

At stage 502, the client can use a computing device 106 to create an account with the virtual agency system. In this stage, the client can provide initial information about the desired employees. For example, the client can provide a staffing service agreement, a facility questionnaire, credit card billing information, and a rate agreement, as indicated in FIGS. 10A-12B and 23. In some embodiments, stage 502 can be executed by a profile generation module within server 104.

The questionnaire can comprises a series of questions for use in determining whether a personnel can be a match for the client's needs. In some embodiments, the questionnaire can ask questions relating to generic experience and skills possessed by the personnel. In another embodiment, the questionnaire can ensure that the personnel can comply with non-skills based requirements of the client, e.g., a dress code.

At stage 504, the client can create an assignment and submit the assignment to the server. In this step, the client can specify information on, among other things, (1) a type of work (e.g., attending a mailroom), (2) a time period of employment (e.g., today from 9 AM-5 PM), (3) a location of work place, and (4) an amount of fee to be paid either upon completion of work or periodically. The server 104 in communication with the client via the computing device 106 can subsequently determine several candidate personnel for the client and send the list of candidate personnel to the client. In some embodiments, the list of candidate personnel can include resumes. In some cases, the resumes can indicate the hourly rate requested by the candidate personnel. In some embodiments, stage 304 can be executed by an assignment generation module within server 104.

At stage 506, the client can initiate an instant match process. As in stage 306 of FIG. 3, the instant match process of this stage matches personnel and clients based on personnel attribute information and client job criteria. In some embodiments, stage 506 can be executed by a match generation module within server 104.

At stage 508, once the server 104 matches an interested potential personnel, the server 104 can notify the client that there is a match. The client may then review the list of candidate personnel and, if applicable, additional information associated with the candidate personnel, and select one or more of them as potential personnel for the assignment. The client can submit the selected potential personnel to the server 104. In some embodiments, stage 508 can be executed by a match notification module within server 104. In some embodiments, a match notification module on client 106 may query or poll server 106 for matches and may notify the client that a match has been made.

At optional stage 510, the server 104 can correspond with the selected potential personnel to see if any of the selected potential personnel is interested in working on the assignment. At this stage, the match can be accepted by the candidate personnel. In some embodiments, stage 510 can be executed by a personnel correspondence module within server 104. In some embodiments, a personnel correspondence module on a client 106 may perform one or more steps of stage 510.

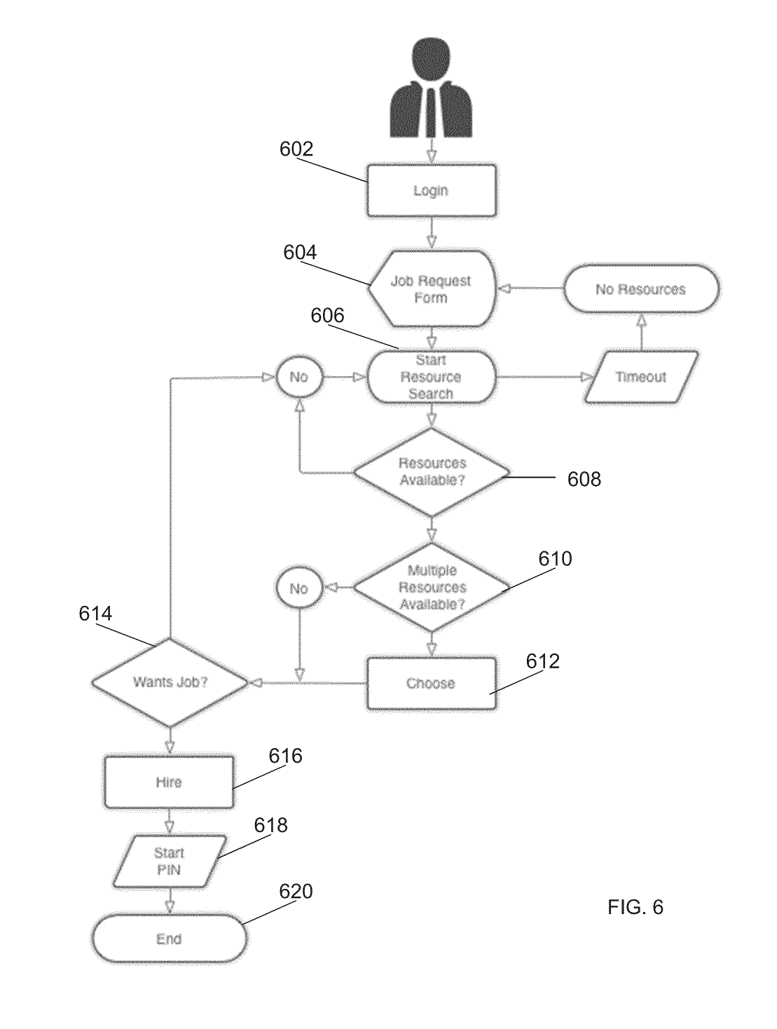

FIG. 6 shows a detailed flowchart of a process experienced by an existing client in a virtual agency system in accordance with some embodiments of the disclosed subject matter. FIG. 6 contains stages 602-620.

At stage 602, the client can use a computing device 106 to login to the system with a previously created account. The client can login to the system at any time to search for available personnel. For a returning client, many previously defined attributes can automatically default to the last used parameter. For example, a preferred job type or payment rate can be automatically defined based on the personnel's previous preferences.

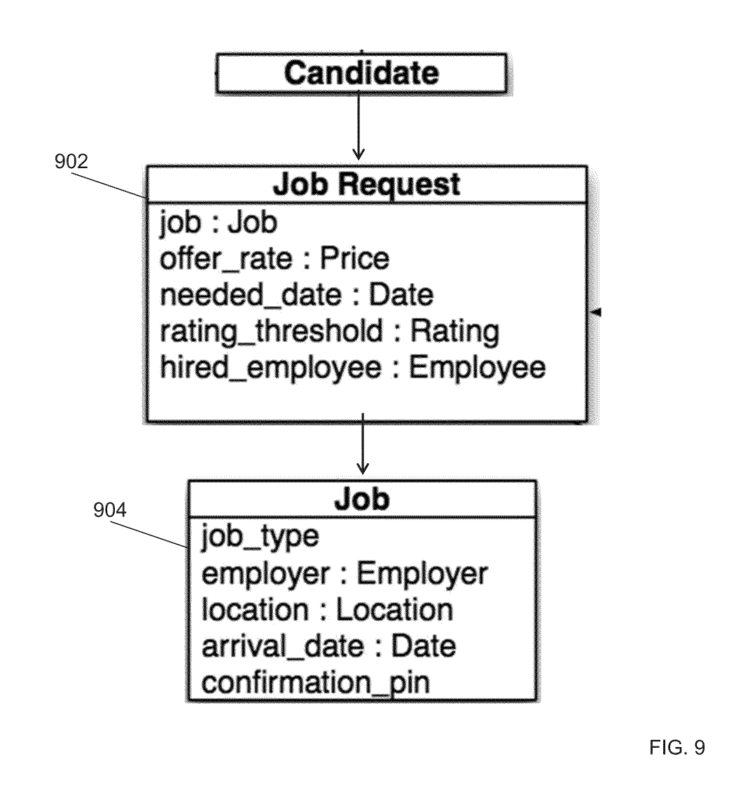

At stage 604, client can complete a job request form, described in more detail in FIG. 9. The job request form contains a number of job criteria desired by the client for prospective employees. Criteria chosen by the client can include, for example, a rate of payment for the work (e.g., an hourly rate), a date that the work will begin, and a minimum rating personnel must hold to be considered for the job. Once the client completes the job request form, the process proceeds to stage 606.

At stage 606, client can begin a search for available resources. This stage is performed at the server 108, and is analogous to stages 306 and 506 of FIGS. 3 and 5. The resource search will attempt to match available personnel with the client based on the criteria provided at stage 604. If no suitable personnel are located within a predetermined time, the process times out and returns to stage 604. If at least one suitable personnel is located, the process proceeds to stage 608.

At stage 608, once the attributes are set, the client can press a ‘Go’ button and the system can provide an animated visual representation of a searching/working icon to inform the client that a matching personnel is being located. The personnel can define an affinity for a specific type of personnel. An affinity represents a preference for a specific type of attribute, and can introduce bias into the matching process to prefer the type of attribute selected.

If no matching personnel are located, the system can request that the client consider changing job criteria to broaden the pool of potential matching personnel. For example, the client can have entered an hourly payment rate that is below all available personnel's minimum rate in their profiles. In this case, the system can directly inform the personnel that no clients matched the rate offered for the job. In another example, the date, time or job type may not match any clients available during the requested period. If none of the identified personnel is available, the process returns to stage 606 to search again. If at least one of the identified personnel is available, the process proceeds to stage 610.

At stage 610, the system determines whether multiple personnel match the client's criteria. If multiple personnel are matched with the client, the client is prompted to select a personnel at stage 612. If only one personnel is matched to the client, the system can alert the prospective client as described in stage 308.

At stage 614, the one or more identified personnel are prompted to accept or reject the offer of a job. This stage is analogous to stage 416 of FIG. 4. If the personnel declines the match, the system indicates to the client that no match was found and returns to stage 606. If the personnel accepts the match, then the client can be informed that a match was located. A match accepted by both the client and the personnel can send an alert to the client of the pending arrival of a matched client. The system can further display the PIN code to give to the personnel to allow him to clock into the system upon arrival.

In the case that multiple personnel match the client's job criteria, all qualified personnel are notified. Those employees that accept the notification of a prospective opportunity can be ranked by the system for the client based on their current proximity to the job, by hourly rate desired, and personnel rated. In addition, the personnel can be sorted based on a bias introduced into the matching process by an affinity for a particular type of personnel defined by the client. Once the interested and matched personnel are identified, the client can be provided an opportunity to view a summary profile of each interested personnel to gain more data (gathered from the attributes of the profile defined in FIG. 8). This process can be timed to ensure personnel have an chance to pursue other opportunities if not selected. Once the client makes a decision, the client can select a “choose” option to send an acceptance notice to the interested personnel and close out the offer to the other waiting, interested personnel.

At stage 618, the system provides the hired personnel with a first specialized code to present at the client's location to indicate arrival for work. This stage is analogous to stage 420 in FIG. 4. In some embodiments, the specialized code can be, for example, a series of numbers that the hired personnel can enter at a computer terminal at a personnel's location. In another embodiment, the specialized code can be in image containing a number in a scannable format. In one implementation, the code can be a bar code that can be scanned by a standard bar code scanner. In another implementation, the code can be a QR code readable by the camera of a smartphone. The process then ends at stage 620.

FIGS. 7-9 show details of parameters that can be associated with a clients and personnel in accordance with some embodiments of the disclosed subject matter. In some embodiments, the parameters comprise data stored in an SQL database, for example, database 208. Other embodiments can use other data structures such as, for example, XML, objected oriented databases, flat files, etc.

FIG. 7 shows a detail of parameters that can be associated with a client in accordance with some embodiments of the disclosed subject matter. In some embodiments, the parameters comprise data stored in an SQL database, for example, database 208. FIG. 7 contains elements 702-714.

Element 702 comprises general information associated with a client. Element 702 can include parameters including, for example, (1) a name associated with the client, (2) contact information, (3) a primary address, (4) a secondary address, (5) a preference, in miles, for a maximum distance away from the client's address for which to search for personnel, (6) a general profile of the client's practice, and (7) a questionnaire to provide personnel to assist in determining whether a prospective personnel is a match for the client's needs. It is appreciated that this list is exemplary only, and other information can be associated with a client in database 108.

Element 704 can include detailed address information associated with the one or more addresses provided by the client in element 702. Element 704 parameters can include (1) a first address line associated with the client, (2) a second address line associated with the client, (3) a city, (4) a state, (5) a zip code, and (6) a special location parameter comprising geographic coordinates associated with the address. These geographic coordinates can be stored as a latitude and longitude associated with the parameters of element 714.

Element 706 can include detailed contact information associated with the contact information provided by the client in element 702. Element 706 comprises parameters including (1) a contact name, (2) a contact number, (3) an email address, and (4) a physical address associated the point of contact. The physical address can further comprise parameters defined in element 704 of FIG. 7.

Element 708 can include a detailed list of questions and responses for determining whether a personnel is a good match for a client. This element further defines the questionnaire provided in element 702. Element 708 comprises parameters including (1) a list of questions to ask personnel, and (2) a list of responses received from personnel in response to the questions.

Element 710 can include payment processing information provided by the client. In some embodiments, this payment processing information can include an ACH payment processing account set up with a bank.

Element 712 can include practice profile information associated with the practice profile provided by the client in element 702. Element 712 tracks an expiration date for a client's license to practice in a particular field.

FIG. 8 shows a detail of parameters that can be associated with a personnel in accordance with some embodiments of the disclosed subject matter. FIG. 8 contains elements 802-808.

Element 802 comprises general information associated with a personnel. Element 802 comprises parameters including (1) a name associated with the personnel, (2) an email address, (3) a home address, (4) a secondary address, (5) a contact phone number an indication of the type of number (e.g., home, work, or cellular), (6) a date of birth, (6) a preferred method of transportation to reach an employer's site in the case of a job match, (7) a list of primary skills possessed by the personnel, (8) a list of secondary skills possessed by the personnel, (9) a wage rate requested by the personnel for services rendered, (10) a secondary rate requested by the personnel for services rendered in accordance with a job requiring only secondary skills, and (11) dates of availability of the personnel. It is appreciated that this list is exemplary only, and other information can be associated with a personnel in database 108.

FIG. 8 also discloses elements storing certifications 804 possessed by the personnel, documents 806 associated with a personnel related to a match, and any immunization documents 808 possessed by the personnel.

FIG. 9 shows a detail of parameters that can be associated with a job request and an associated job to match personnel and clients in accordance with some embodiments of the disclosed subject matter. FIG. 9 contains elements 902 and 904.

Element 902 comprises detailed information associated with a client's job request. Element 902 comprises parameters including (1) a title of a job, (2) an offer rate for the job, (3) a date for required work, (4) a minimum personnel rating required by the employer, and (5) a placeholder indicating a name of an employee who is hired to fill the position.

Element 904 comprises detailed information associated with a job accepted personnel. Element 904 corresponds to information provided to a personnel upon accepting an offered job. Element 904 comprises parameters including (1) a type of job that has been accepted, (2) a name of the employer providing the job, (3) a location of the employer's business, (4) a date on which the job is to be performed, and (5) a confirmation PIN code to be used to clock into the employer's work site upon arrival.

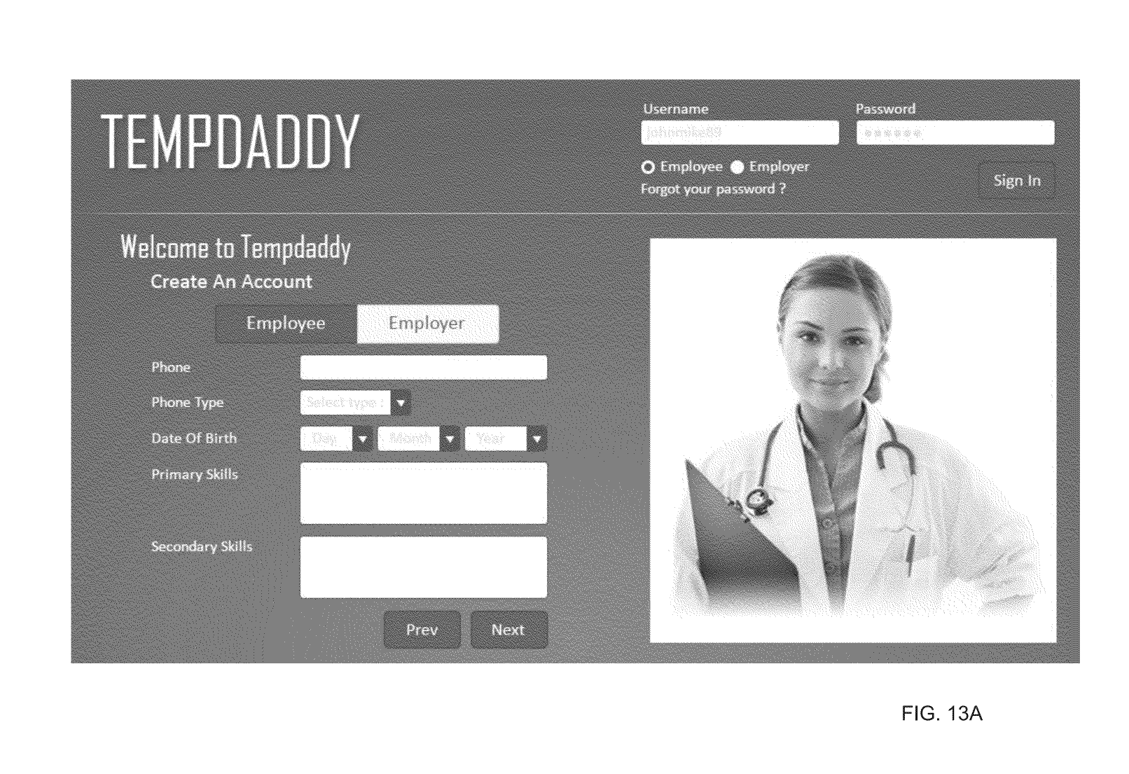

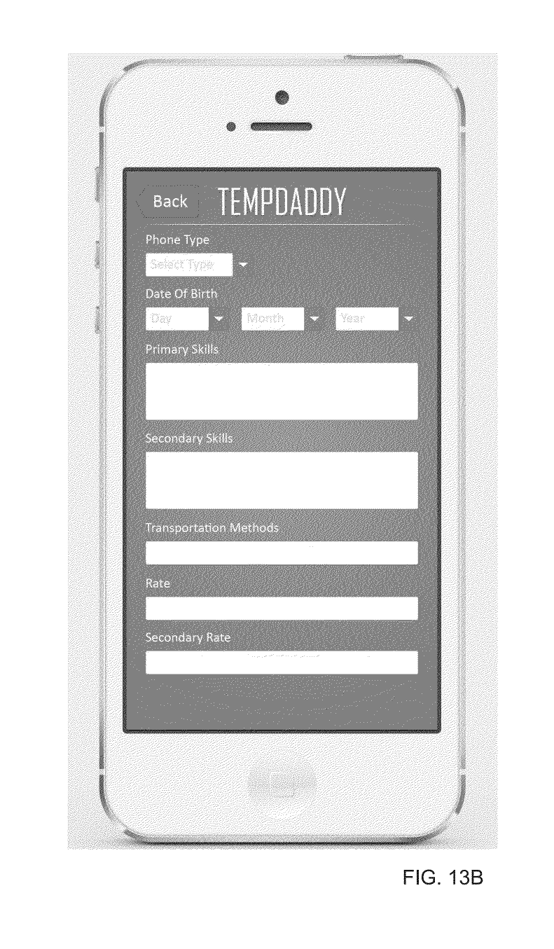

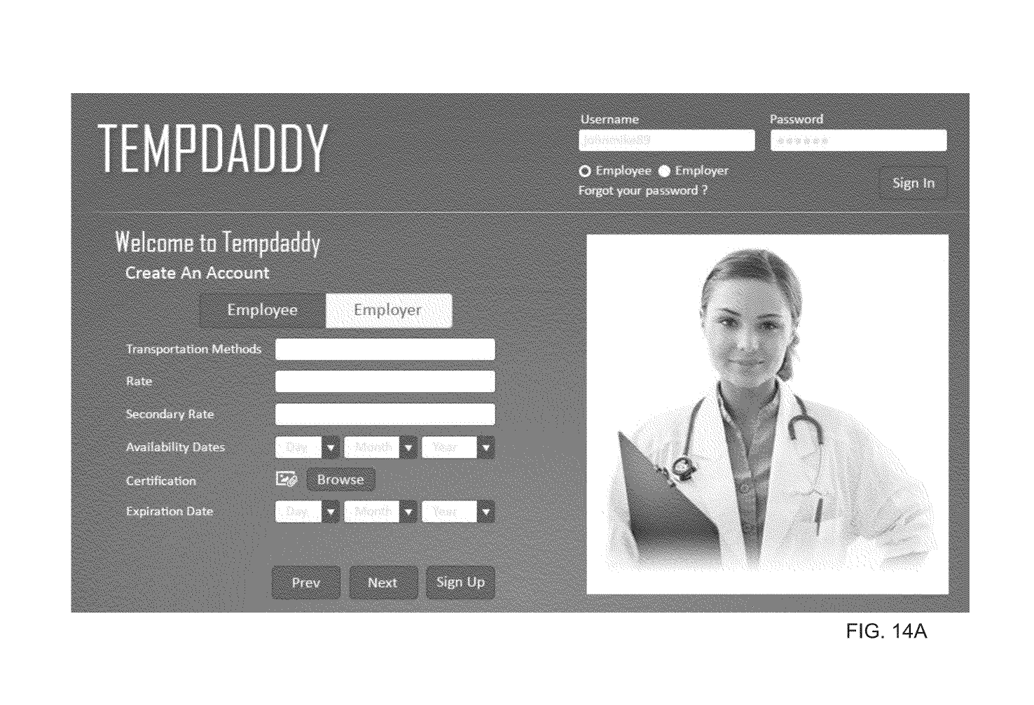

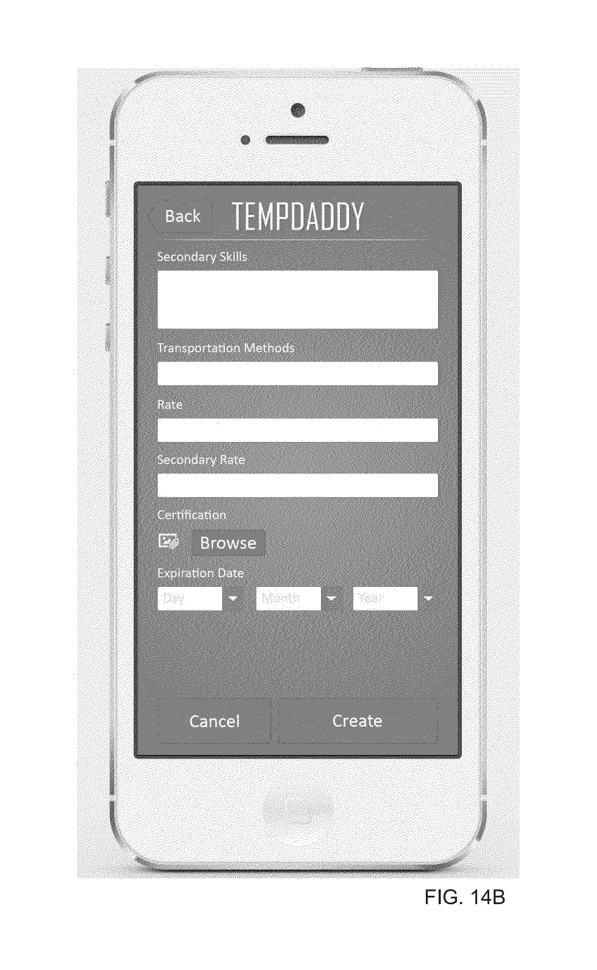

FIGS. 10-26 provide exemplary screen captures of particular interactions with the virtual staffing system in accordance with some embodiments of the disclosure.

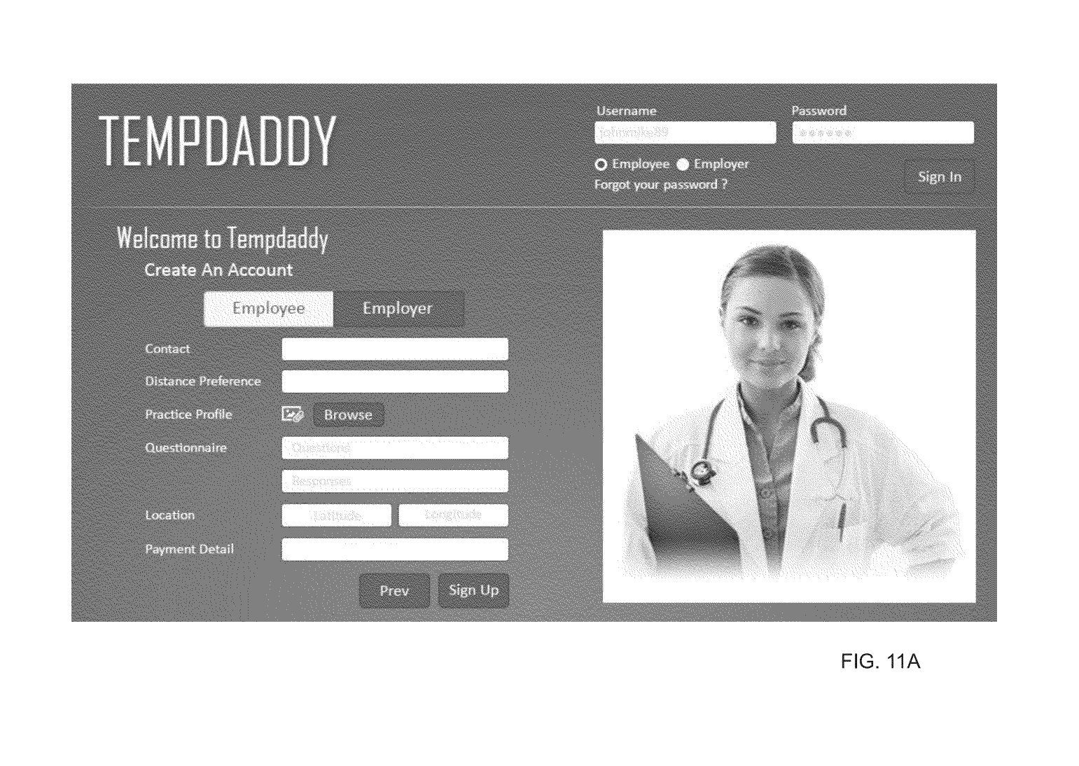

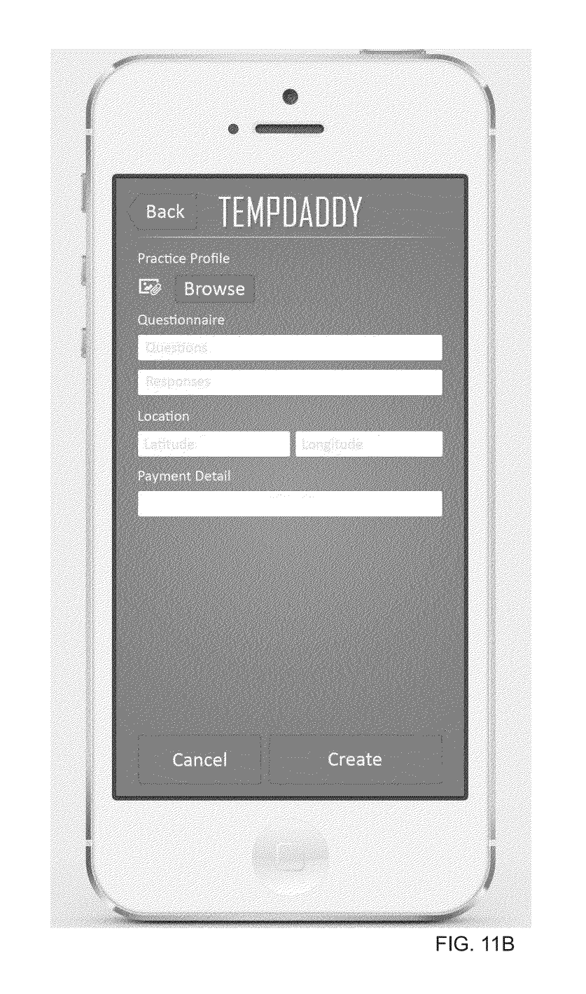

FIGS. 10A, 10B, 11A, and 11B show an example of the sign up process for a client on both a desktop and mobile browser. In accordance with the disclosure of FIGS. 10A, 10B, 11A, and 11B, a client can provide details to associate with the client's account as well as specific job criteria to provide for a particular job position. These figures correspond to the signup process detailed in stages 502 and 504 of FIG. 5 for a client. In this exemplary embodiment, using these screens, the client can provide information including (1) a full name of the client, (2) an email address, (3) a desired password, (4) a primary address of the client's location, (5) a secondary address, (6) a contact phone number, (7) a maximum distance preference from the client's location that a matching personnel can be located, (8) a detailed profile of the client's practice, (9) a questionnaire to assist in the matching process, (10) the geographic coordinates of the client's location (to assist in the matching process), and (11) a method of payment to pay the personnel.

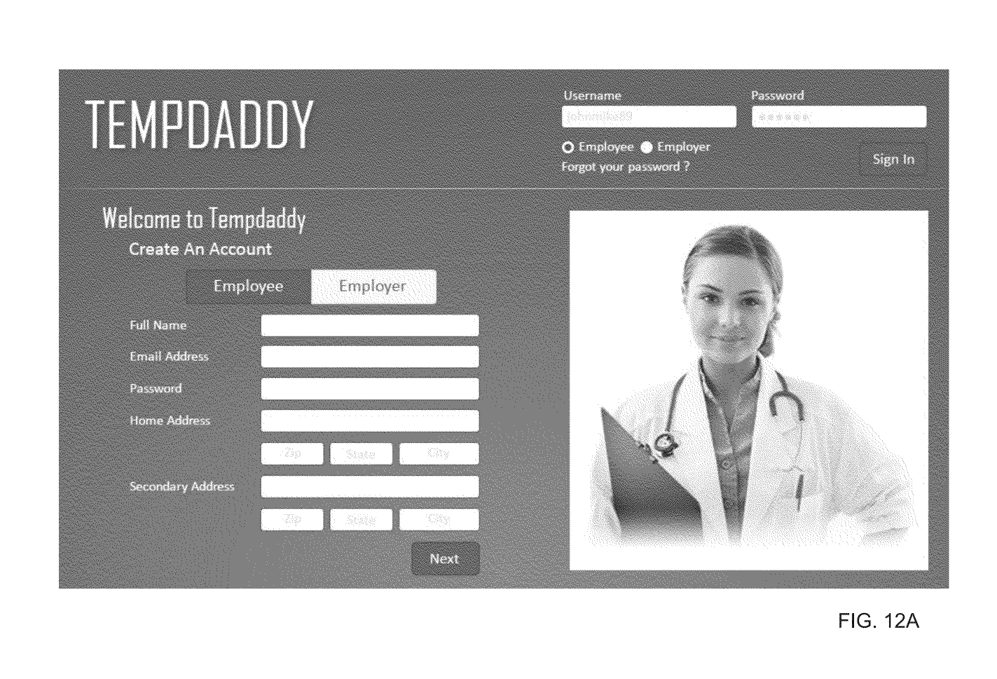

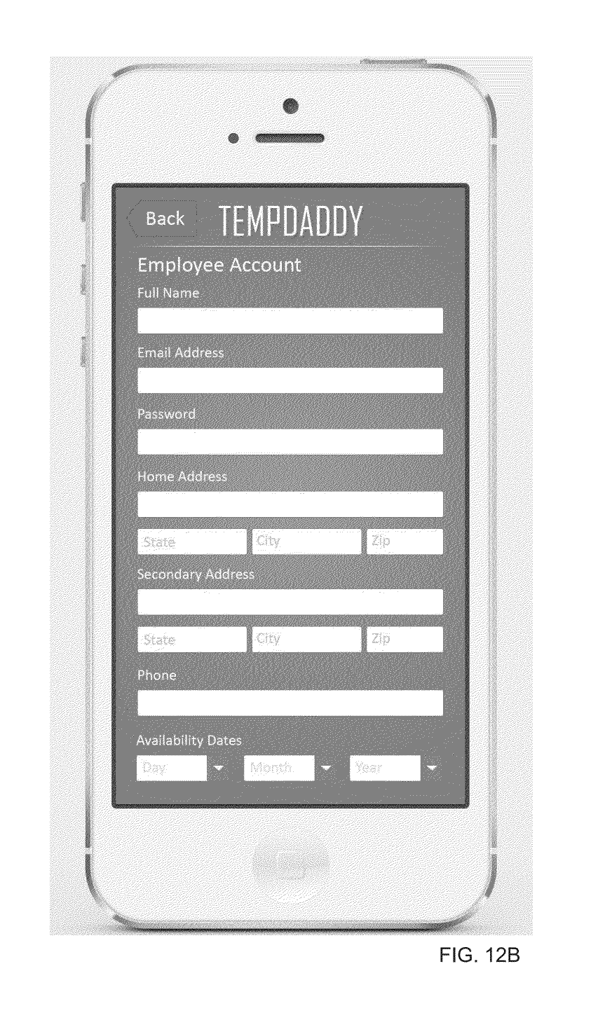

FIGS. 12A, 12B, 13A, 13B, 14A, and 14B show an example of the sign up process for a personnel on both a desktop and mobile browser. In accordance with the disclosure of FIGS. 12A, 12B, 13A, 13B, 14A, and 14B, a personnel can provide details to associate with the personnel's account. These details correspond to attribute information provided by the client in stages 302 and 304 of FIG. 3. In this exemplary embodiment, using these screens, the personnel can provide information including (1) a full name of the personnel, (2) an email address, (3) a desired password, (4) a home address, (5) a secondary address, (6) a contact phone number, (7) a type of phone number provided, (8) a date of birth for the personnel, (9) a list of primary skills possessed by the personnel, (10) a list of secondary skills possessed by the personnel, (11) a list of transportations methods available to the personnel for reaching the client's location (e.g., via car, foot, or public transportation), (12) a payment rate desired, (13) a secondary payment rate desired if the first payment rate is unavailable, (14) dates of availability to work, (15) a certification possessed by the personnel, and (16) an expiration date of the certification.

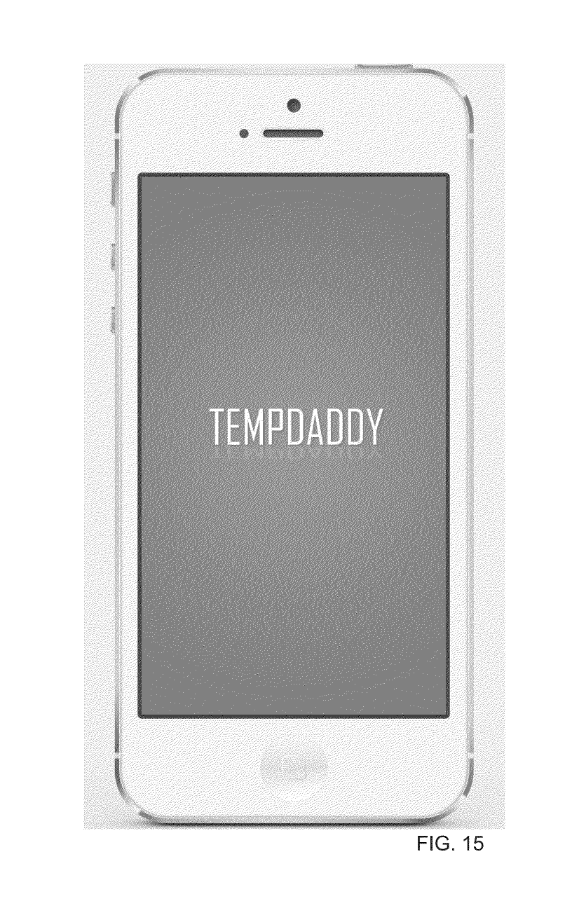

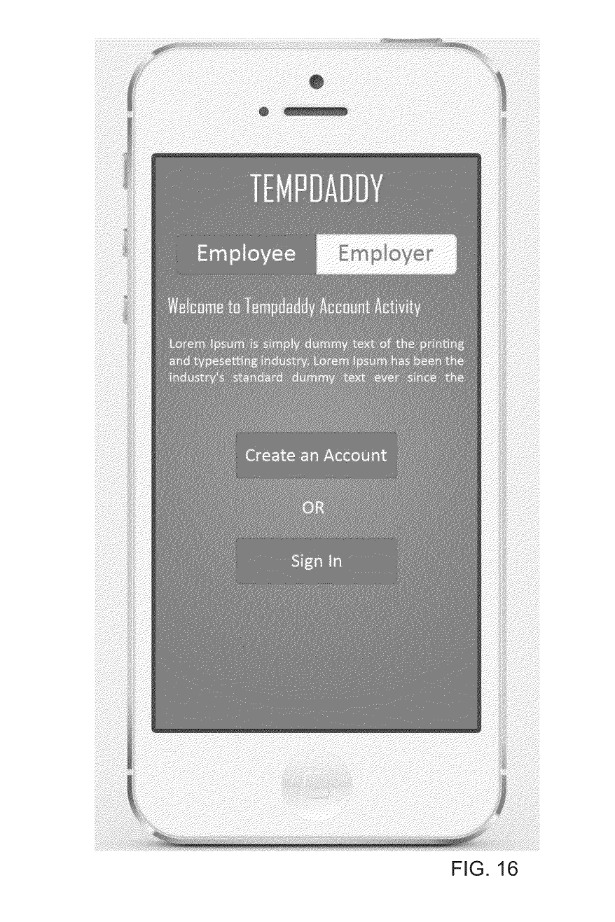

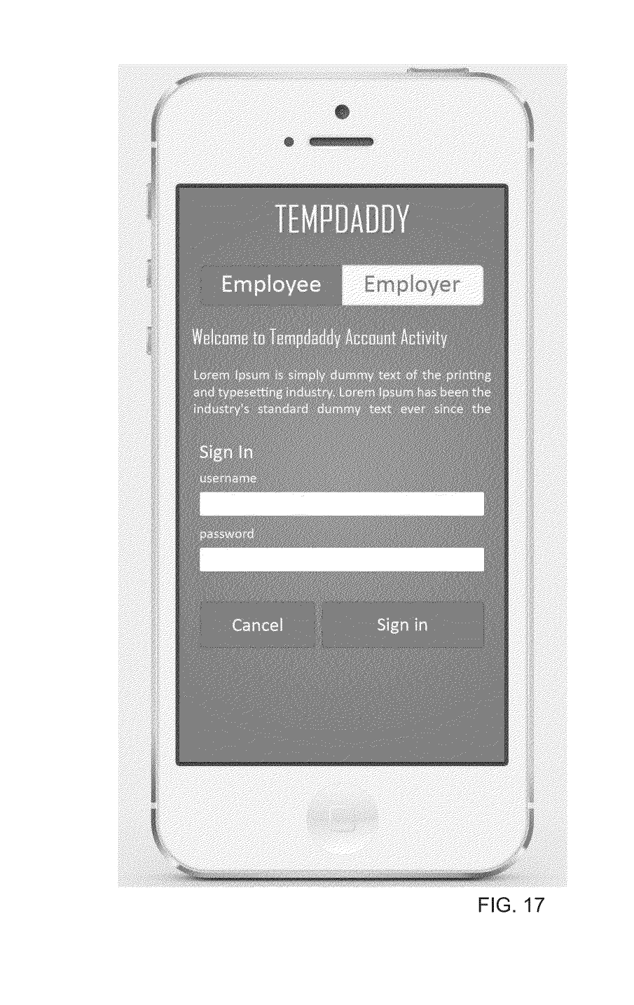

FIGS. 15-17 show a sample of the mobile web interface for logging into the system for a client in accordance with some embodiments of the disclosure. FIG. 15 represents an introductory view presented to a user while the mobile application is loading. FIG. 16 shows options to either sign up with a new account or log into an existing account for a client. FIG. 17 demonstrates the screen provided when a client selects the “log in” option in FIG. 16. The client can log into the interface at FIG. 17.

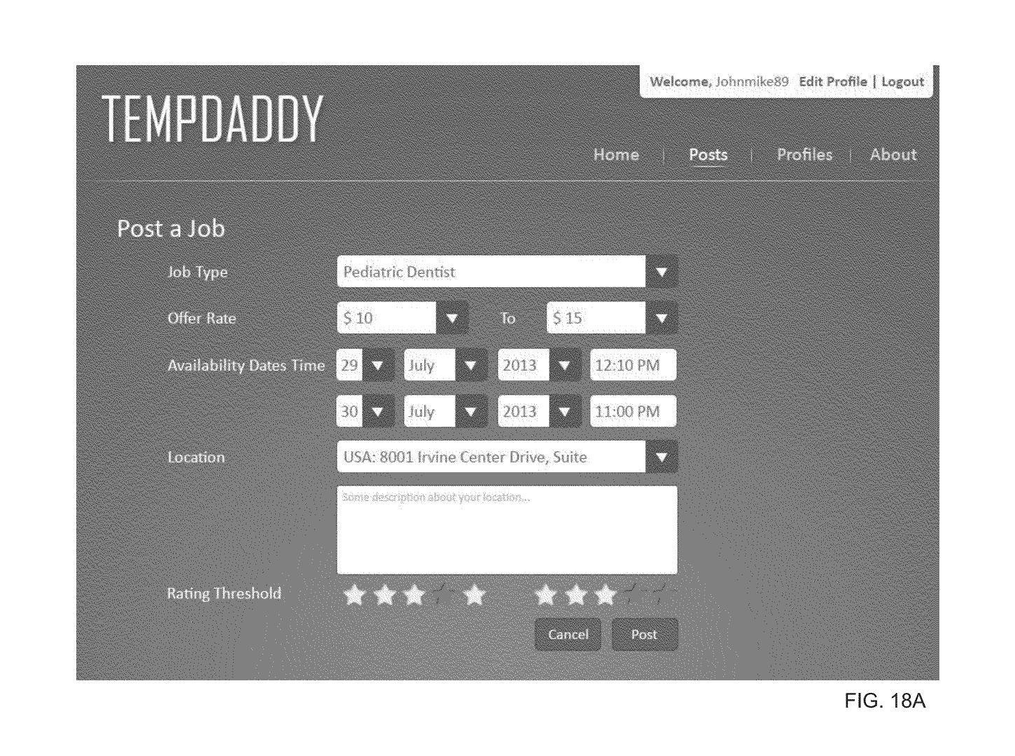

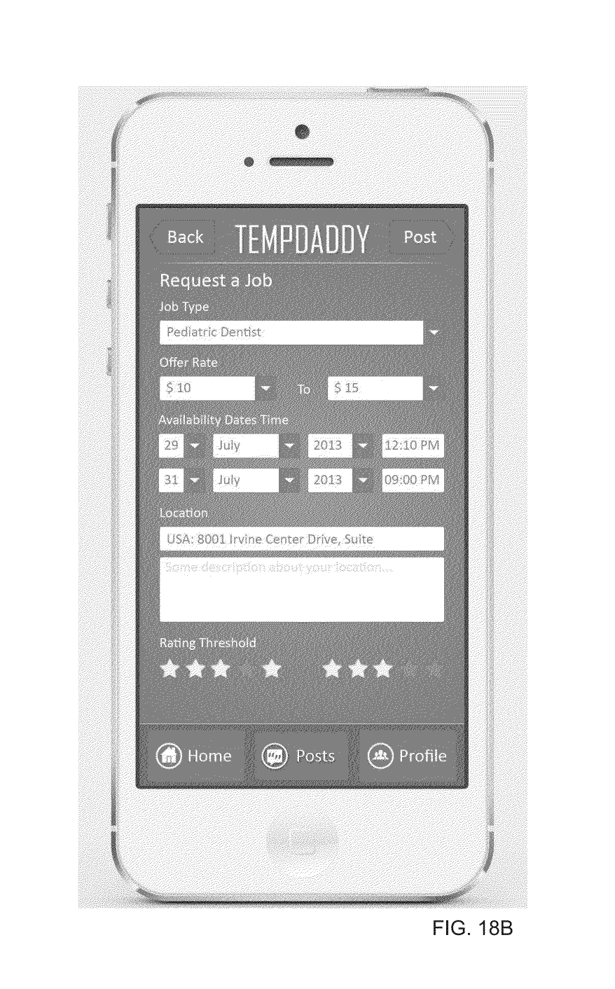

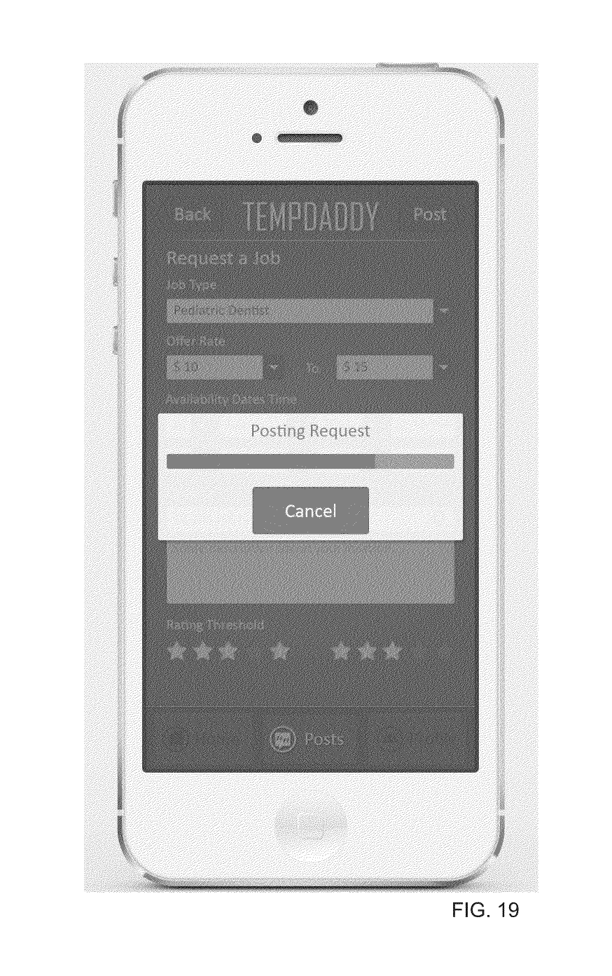

FIGS. 18-21 show a sample of the desktop and mobile web interfaces for posting a job to the system for a client in accordance with some embodiments of the disclosure. FIG. 18 provides a job request form for a client. In FIGS. 18A and 18B, the client can indicate a type of personnel being sought. In this example, the job type is a “pediatric dentist.” The client can further provide a range of wages that the client is willing to offer for the position. In this example, the range of wages offered is $10 to $15 per hour. The client can also provide a range of available dates and times for the position, as well as the specific location of the job and a minimum desired rating for matched personnel. In FIG. 19, the client selects the “post” option and the system posts the job to the virtual staffing agency's server.

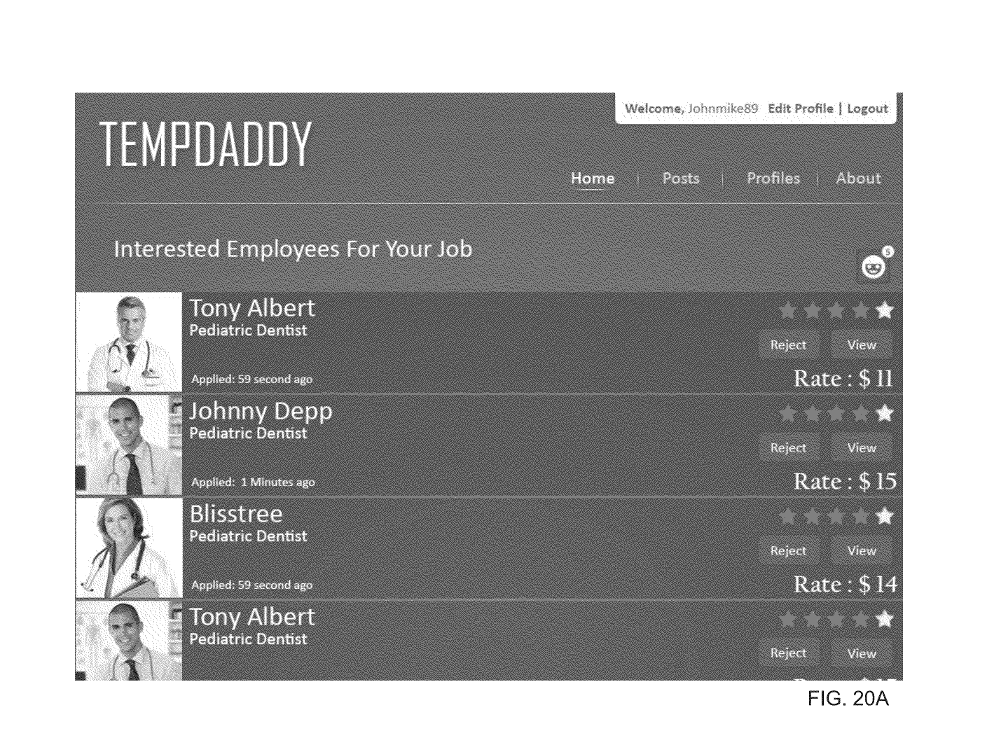

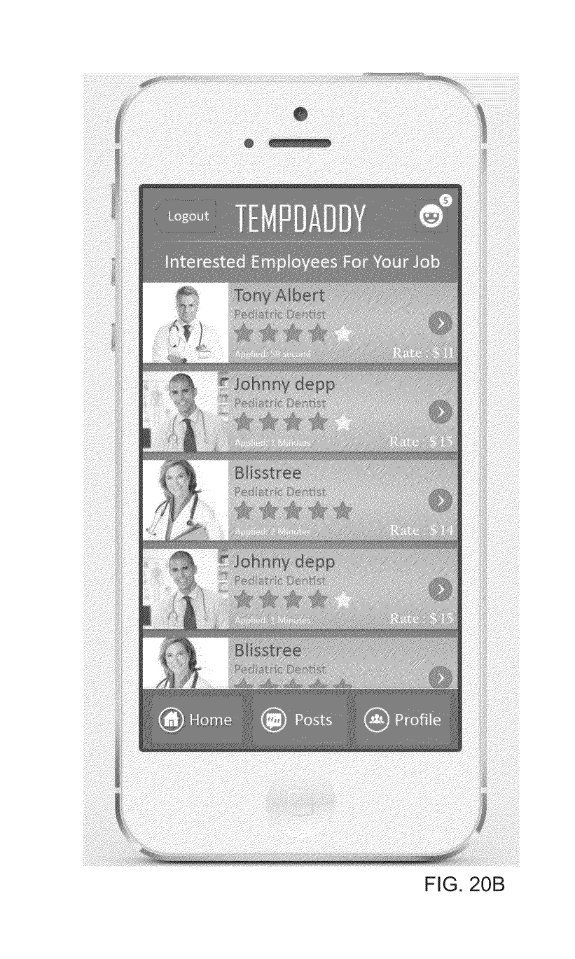

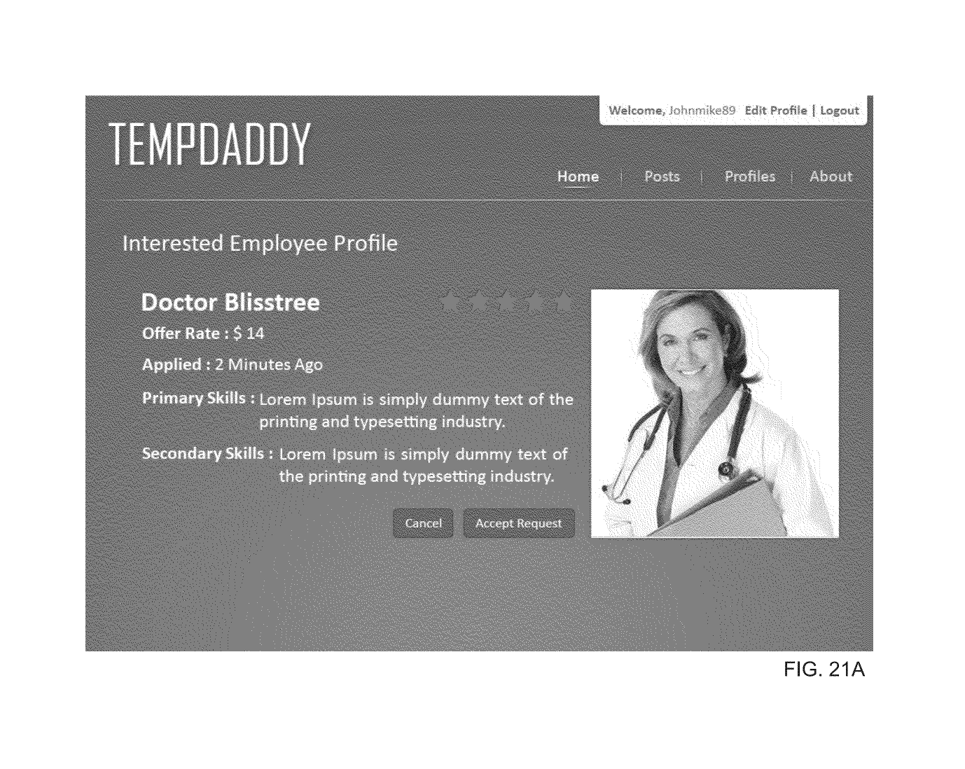

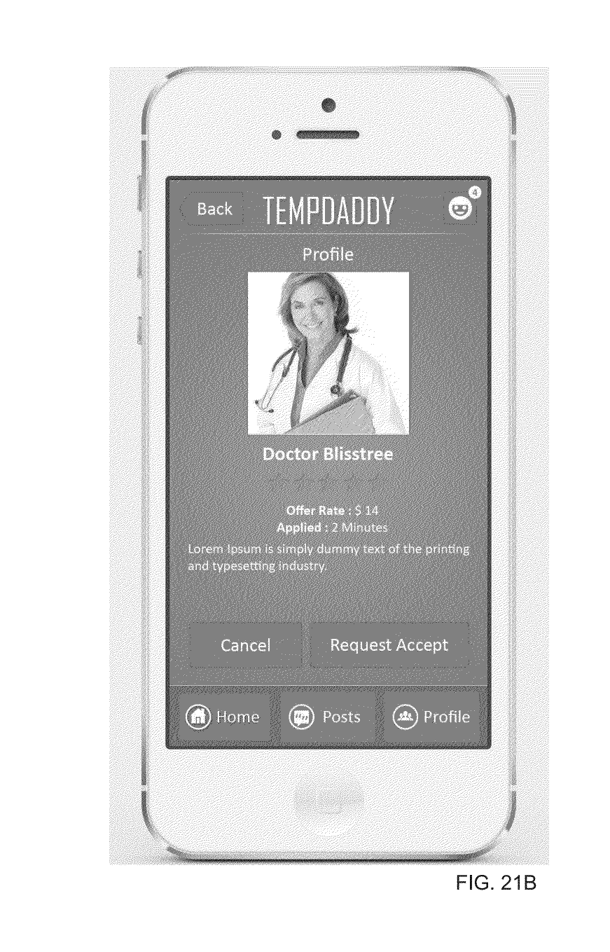

At FIGS. 20A and 20B, a list of personnel whose attributes have matched the client's job criteria are provided to the client. This view corresponds to stage 506 of FIG. 5. The list of matched and interested personnel can be ordered by the client's affinity for particular resources, as well as by an offer rate and present location provided by the a device 106 of the personnel. The client can select the profile of a matched personnel to enter the view shown in FIGS. 21A and 21B. This view provides details regarding the matched personnel, including the offer rate and primary and secondary skills associated with the personnel. From this view, the client can accept a personnel's offer and hire the personnel for the position.

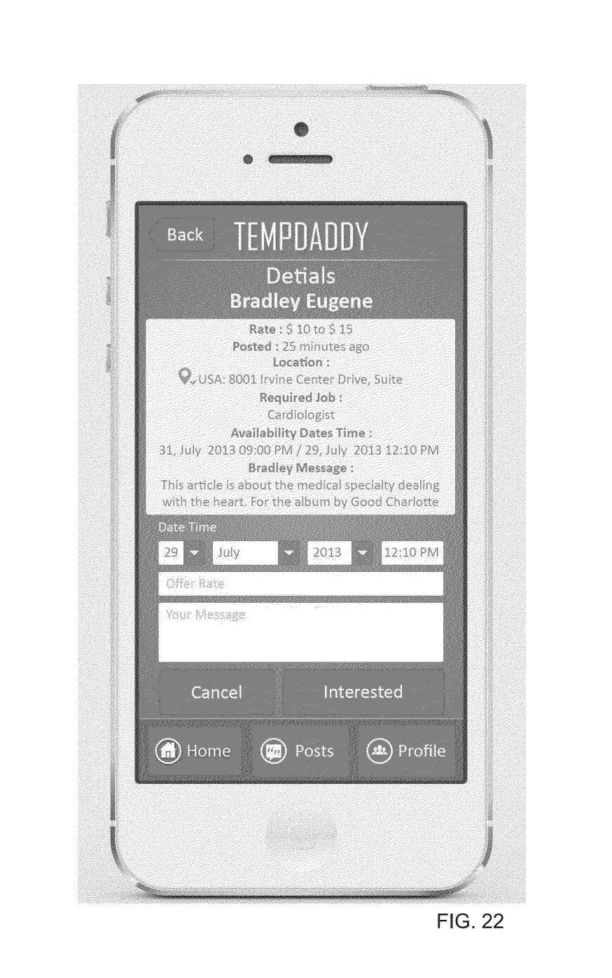

FIG. 22 provides an exemplary screen presented to a matched personnel in accordance with an embodiment of the disclosure. In this embodiment, the personnel can be provided details of the matched job, including an offer rate, a location, the job type, availability dates, and any supplementary information. The personnel can express interest by selecting the “interested” icon at the bottom of the screen. The personnel can then wait for the client's response to this indication.

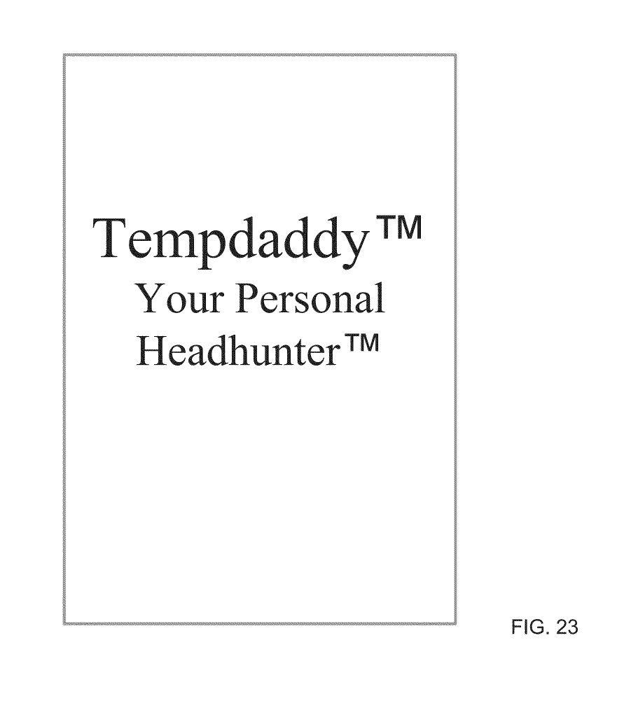

FIGS. 23-33 show exemplary screenshots of an embodiment of virtual agency system application seen by a personnel in accordance with some embodiments of the disclosed subject matter.

FIG. 23 illustrates a main application page in accordance with some embodiments. When a personnel selects the application, the main application page of FIG. 23 will appear. This page corresponds to the screenshot of FIG. 15. While the main application page is on, the application can load the client's profile information so that that application can provide a list of candidate personnel tailored to the client's needs. The client's profile information loading can take place seamlessly during the application loading process.

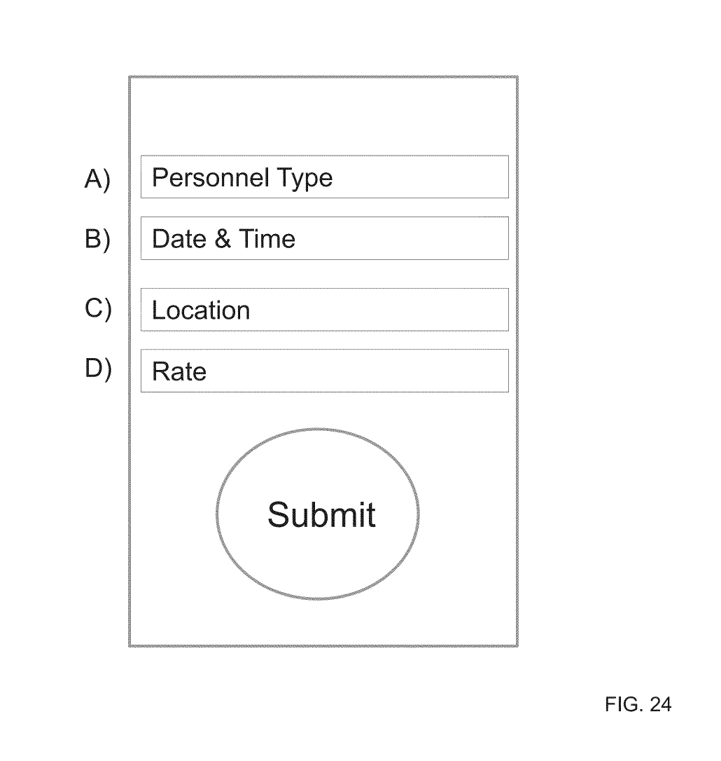

FIG. 24 illustrates an exemplary assignment generation page that allows a client to provide details of a new job assignment. The client can select one of the icons on the assignment generation page to provide the associated information.

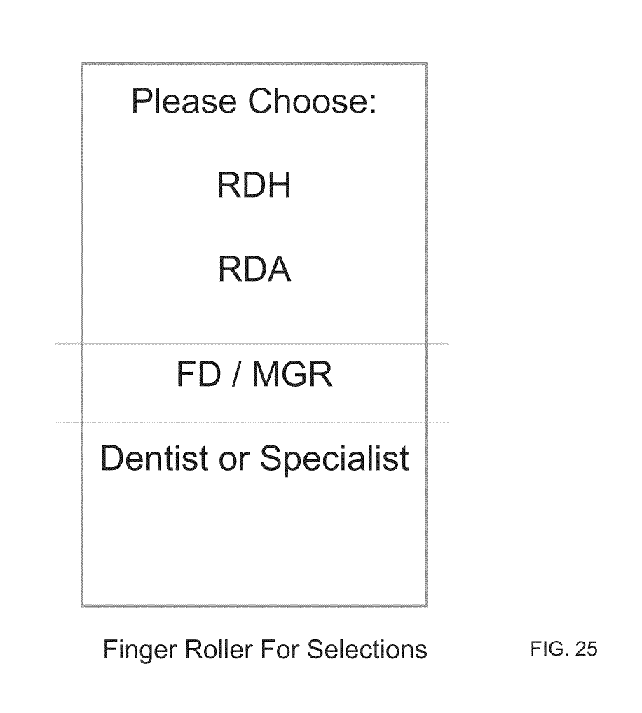

In some embodiments, the “personnel type” icon allows the client to select the candidate personnel type. The client can select the candidate personnel type based on the client's industry and/or the candidate personnel's qualifications. In some cases, the application can automatically provide options for the candidate personnel type based on the client's profile information. This screen corresponds to FIGS. 18A and 18B above. The options can be generated locally at the computing device 106 or remotely at the server 104. These options can be provided to the client when the client selects the “personnel type” icon. FIG. 25 can illustrate potential options for the candidate personnel type provided to the client in response to the selection of the personnel type icon in accordance with some embodiments. For example, based on the client's profile information relating to Dentistry, the application can provide options that the client can choose from, including a Front Desk/Manager, a registered dental hygienist (RDH), and a registered dental assistant (RDA).

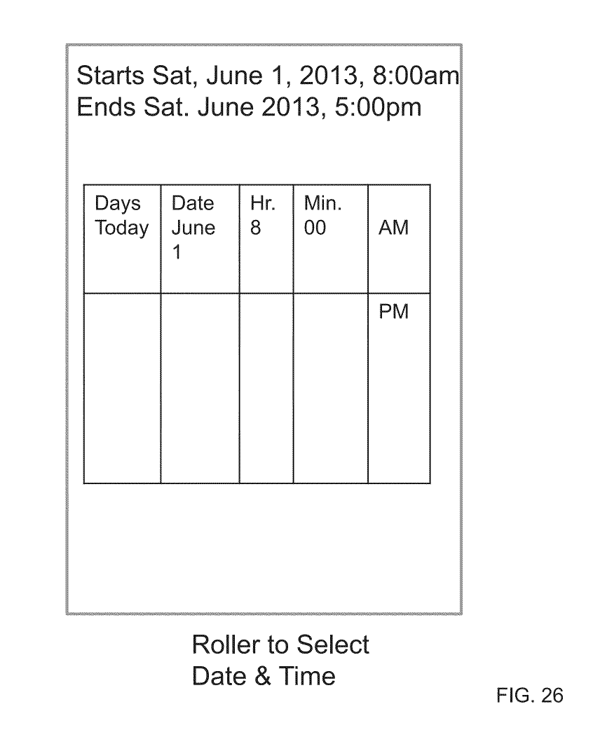

In some embodiments, the “date and time” icon allows the client to select the date and time in which the candidate personnel is needed. When the client selects the “date and time” icon, the application can provide an interface for selecting the date and time. FIG. 26 illustrates an interface for selecting the date and time in accordance with some embodiments. FIG. 26 shows that the user has selected, as the start time, Today Jun. 1, 2013, 8 AM, and as the end time, Today Jun. 1, 2013, 5 PM.

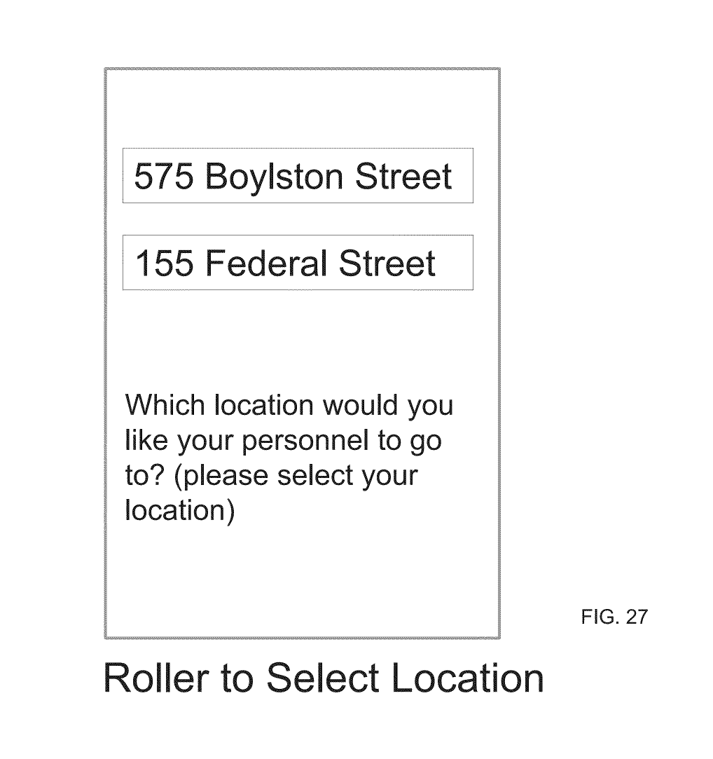

In some embodiments, the “location” icon allows for clients with multiple locations to use the same interface to select a specific location that is in need of candidate personnel based on the locations associated with the client profile. When the client selects the “location” icon, the application can provide an interface for selecting location. FIG. 27 illustrates an interface for selecting the location in accordance with some embodiments. In this figure, the client has selected his location at 575 Boylston Street from the addresses associated with the client profile information.

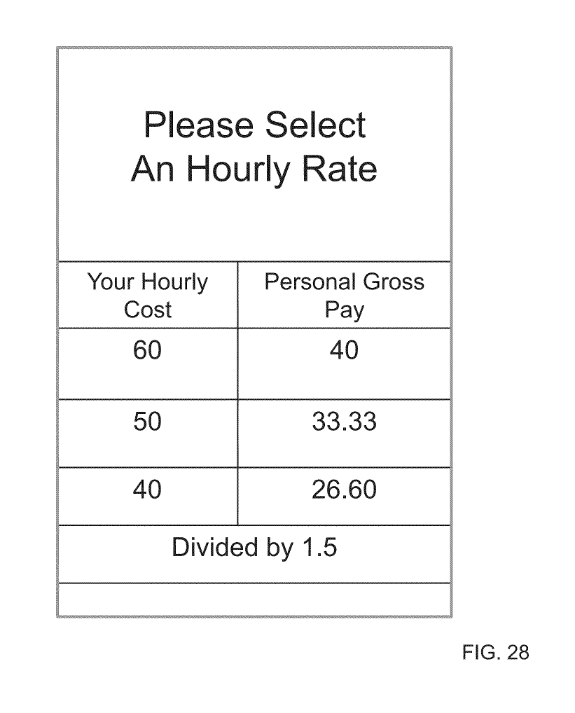

In some embodiments, the “rate” icon allows for the client to set an hourly rate prior to sending the assignment. When the client selects the “rate” icon, the application can provide an interface for selecting the rate. FIG. 28 illustrates an interface for selecting the rate in accordance with some embodiments. The price roller can allow the client to view, simultaneously, their selected hourly wage with the actual hourly wage that the candidate personnel would be compensated (which is the selected hourly rate minus the cost and the management fee). This would allow the client to transparently choose the rate with no cost surprises and be able to see the candidate personnel's pre-taxed net pay prior to submitting the candidate personnel request out to the main hub. All these operations can occur in real time.

Once the client has selected one or more of parameters associated with the assignment, the client can submit the assignment to a server 104. This operation corresponds to stage 504 of FIG. 5 above. The server 104 can subsequently review the assignment and select candidate personnel for the assignment. Then the server 104 can provide the selected candidate personnel to the computing device 106 operated by the client.

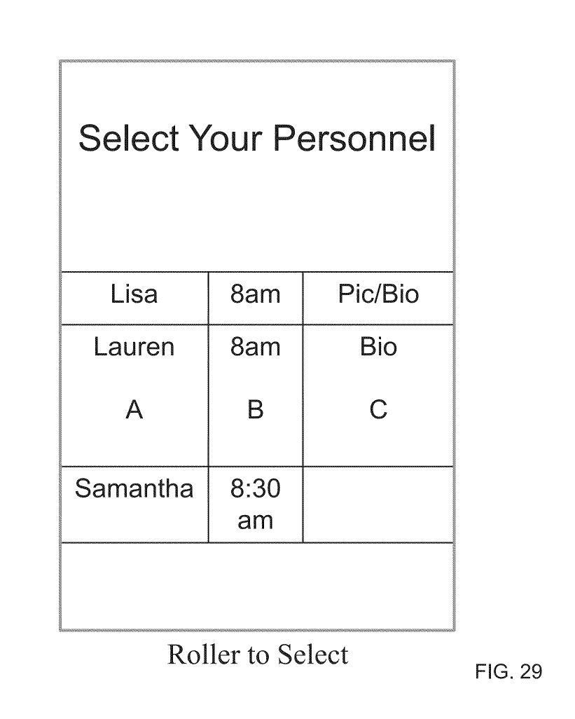

FIG. 29 illustrates an interface that displays the selected candidate personnel in accordance with some embodiments. This figure corresponds to FIGS. 20A and 20B above. This interface can allow a client to see a predetermined number of available candidate personnel. In some embodiments, the predetermined number can be three. In some embodiments, the client can use a transparent roller to go up and down on each candidate's profile and tap on it for selection based on one or more of the following parameters: (A) star system survey by previous clients, (B) estimated arrival time of the candidate personnel, and (C) brief bio with a picture.

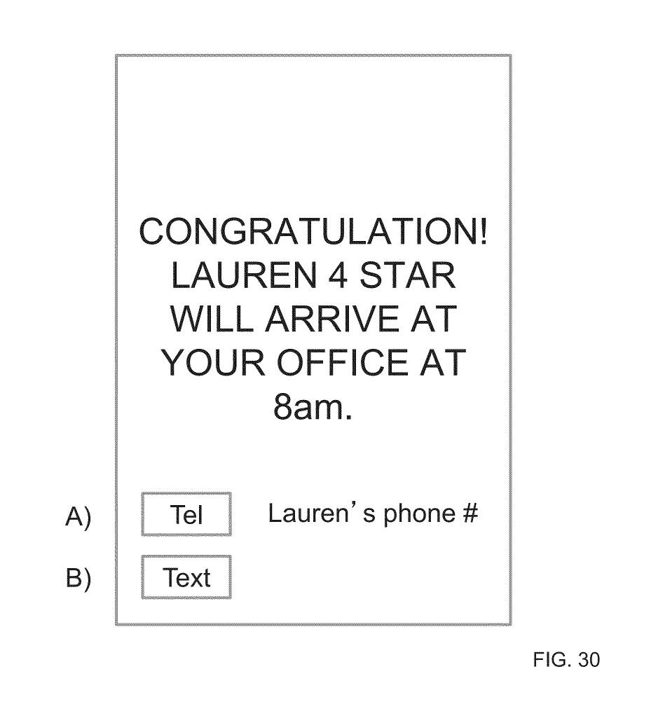

Once the client selects one or more of the candidate personnel and submits the selection to the server 104, the server 104 can contact the selected candidate personnel to determine if the selected candidate personnel can work on the assignment, as discuss above at stages 308 and 310 of FIG. 3. If the server 104 is able to find a match (i.e., the selected candidate personnel indicates that she/he can work on the assignment), then the server 104 can notify the client of the match. FIG. 30 illustrates an interface notifying the match in accordance with some embodiments. The interface can confirm the matching process. In some cases, the interface can also provide an estimated arrival time of the personnel. The estimated arrival time of the personnel can be determined based on a global positioning system (GPS) technology. For example, the server 104 or the computing device 106 can determine the estimated arrival time of the personnel by providing the coordinate to a mapping system, such as Google Maps®, and receiving the estimated time from the mapping system. In addition, the interface can provide an option for the client to call the personnel, as indicated stage 418 of FIG. 4. This way, the client can communicate further arrangements/instructions to the personnel.

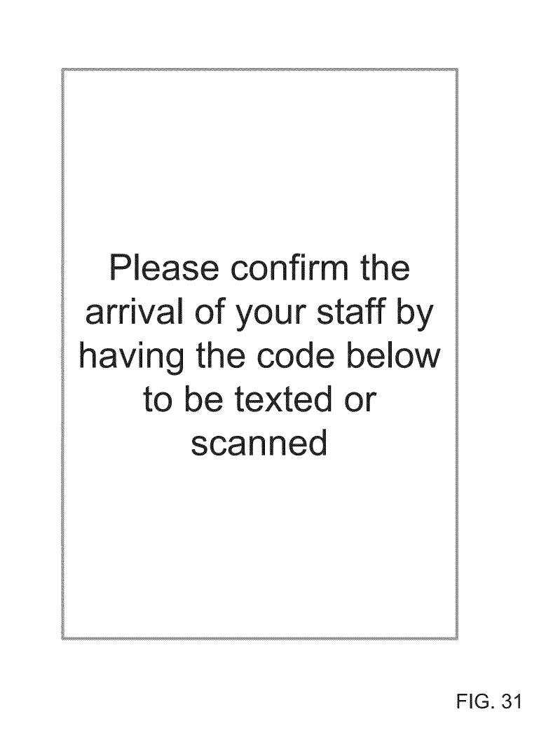

In some cases, the client might not be located at a place in which the assignment is to be performed. To provide a mechanism for tracking the arrival of the personnel, the client can require the personnel to confirm the arrival by scanning a scannable code upon arrival at the work site, as discussed in stage 420 of FIG. 4. This way, the client can be notified when the personnel actually arrives at the work site. In some embodiments, the client can receive the scannable code, to be scanned by the personnel, from the server. In other cases, the personnel's computing device 106 can provide its location (e.g., its GPS coordinate) to the server 104, and the server 104 can notify the client of the location of the personnel. This way, the client can ensure that the personnel is at the work site during the time period of employment. FIG. 31 illustrates an interface for requiring the personnel to provide the scan of the scannable code in accordance with some embodiments. In some embodiments, the client can require the personnel to scan the scannable code upon the arrival, departure, and clock IN/OUT throughout the day. The scannable code can include a bar code or a QR code. The scannable code can be uniquely generated for the personnel.

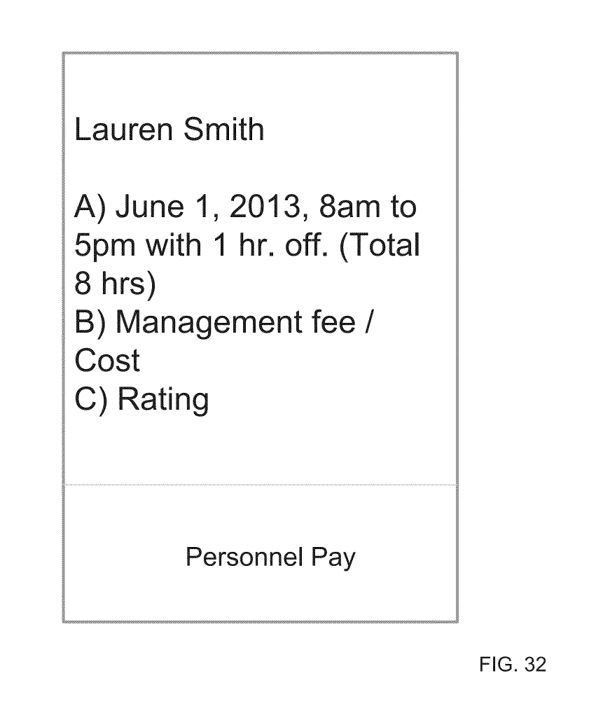

Upon completion of the work, the client can receive a work ticket item receipt. FIG. 32 illustrates a work ticket item receipt in accordance with some embodiments. The work ticket item receipt can also allow the client to fill out a survey. For example, (A) illustrates the date and the number of the hours worked by the candidate personnel; (B) illustrates the total fee charged to the client's account and the cost break down; and (C) allows the client to rate the personnel based on a star system (e.g., a 7-star system).

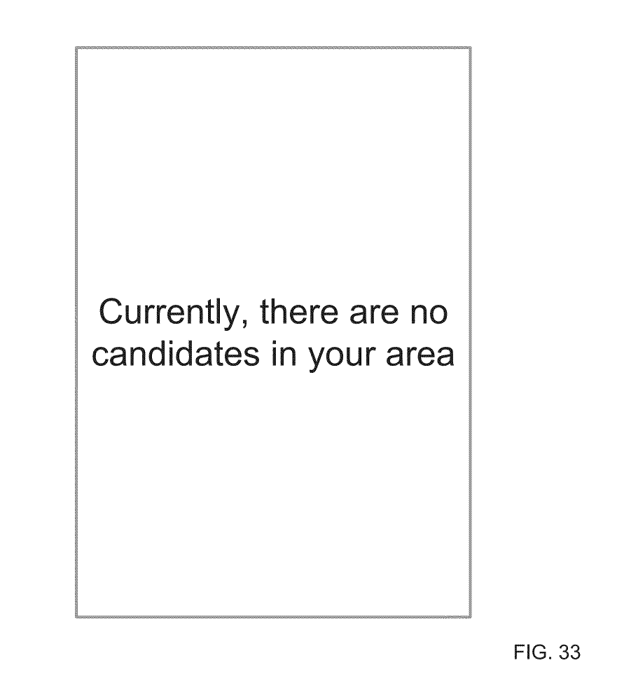

In case the server 104 cannot identify a personnel for the assignment, the server 104 can notify the client that no personnel has been found. FIG. 33 illustrates an interface for notifying that no personnel has been found for the assignment in accordance with some embodiments. This interface can notify the client that there are no candidate personnel matching the assignment and to re-visit the application at a later time.

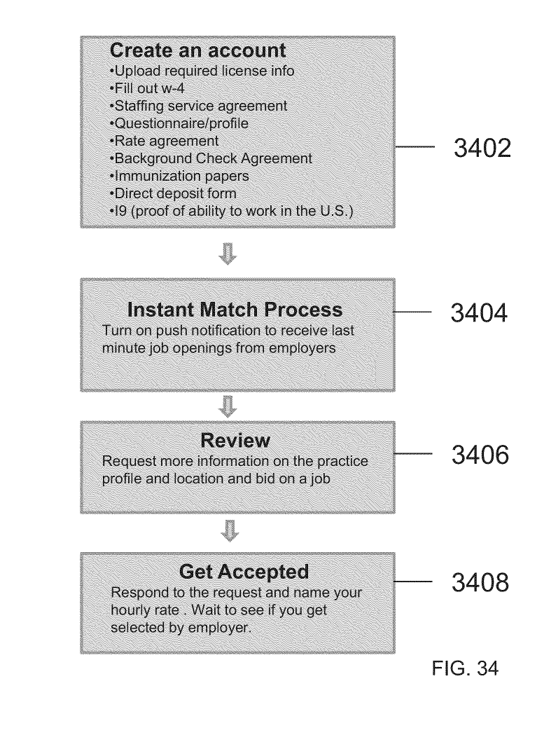

FIG. 34 shows a flow diagram of a process experienced by a personnel in a virtual agency system in accordance with some embodiments of the disclosed subject matter. In step 3402, the personnel can use a computing device 106 to create an account with the virtual agency system. In this step, the client can provide information on (1) licenses held by the personnel, (2) w-4 form, (3) staffing service agreement, (4) questionnaire/personnel profile, (5) rate agreement, (6) background check agreement, (7) immunization papers, (8) direct deposit form, and (9) the proof of ability to work, such as a 19 form in the U.S.

In step 3404, the personnel can turn on a push notification function on its computing device 106 to receive job openings/assignments from clients. In step 3406, the personnel can review the notifications received, and, if needed, request more information on the practice profile and location and bid on a job. In step 3408, the personnel can respond to the assignment request and name the hourly rate. Subsequently, the personnel can wait to see if the personnel is selected by the client.

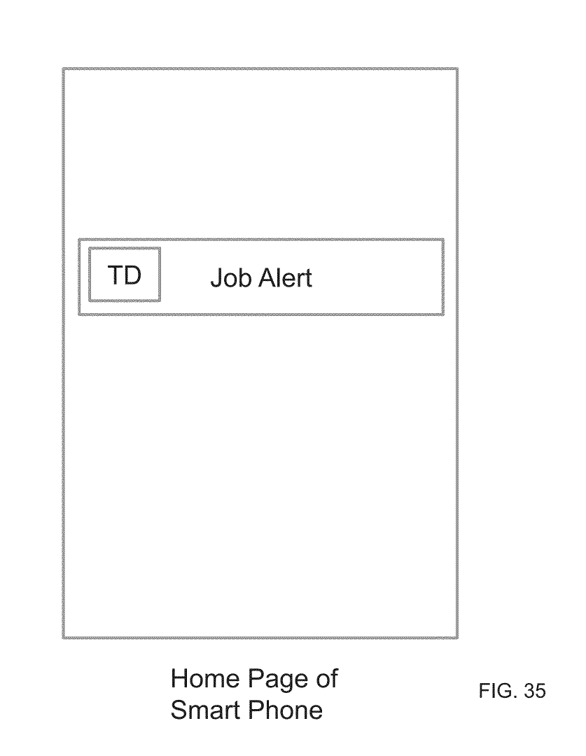

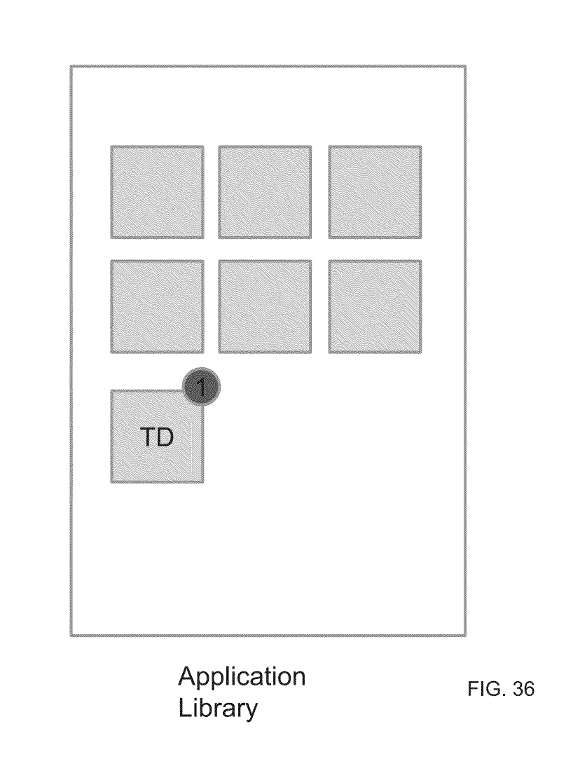

FIGS. 35-44 show exemplary screenshots of a virtual agency system application seen by a candidate personnel in accordance with some embodiments of the disclosed subject matter. FIG. 35 illustrates a notification of assignments in accordance with some embodiments. The notification can be received as a push notification or as a text message. This notification can also appear as a flag on an application icon in the application library, as illustrated in FIG. 36 in accordance with some embodiments. In response to receiving the notification, the personnel can launch the mobile application and wait for the main page to load up. In some embodiments, while the information is getting loaded and the application is launched, the application can use the GPS technology to calculate one or more of (1) the distance to the work place associated with the assignment and (2) the estimated travel time to the work place.

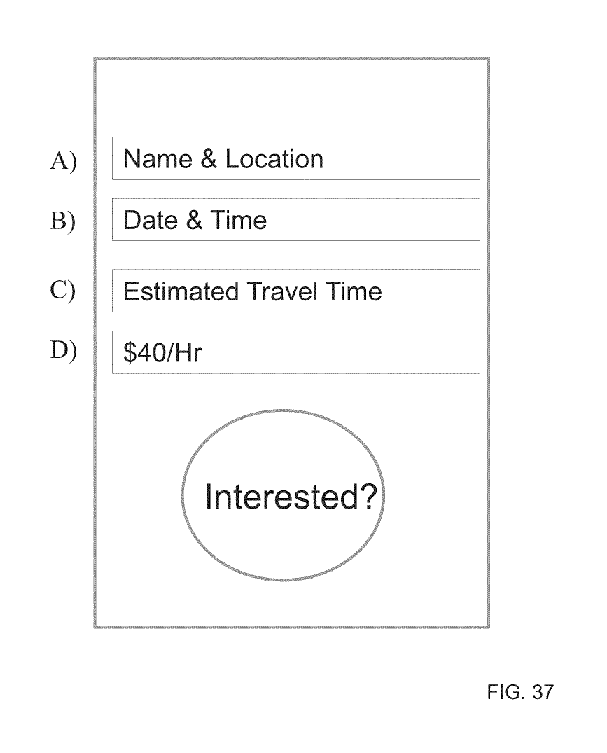

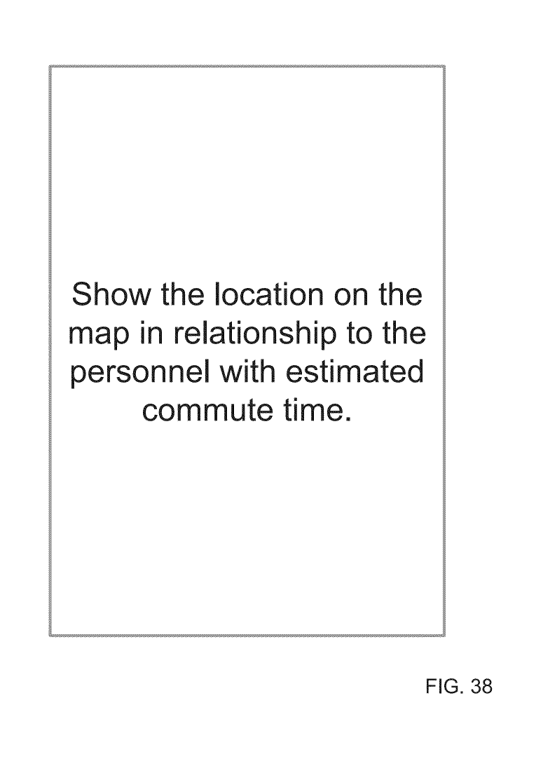

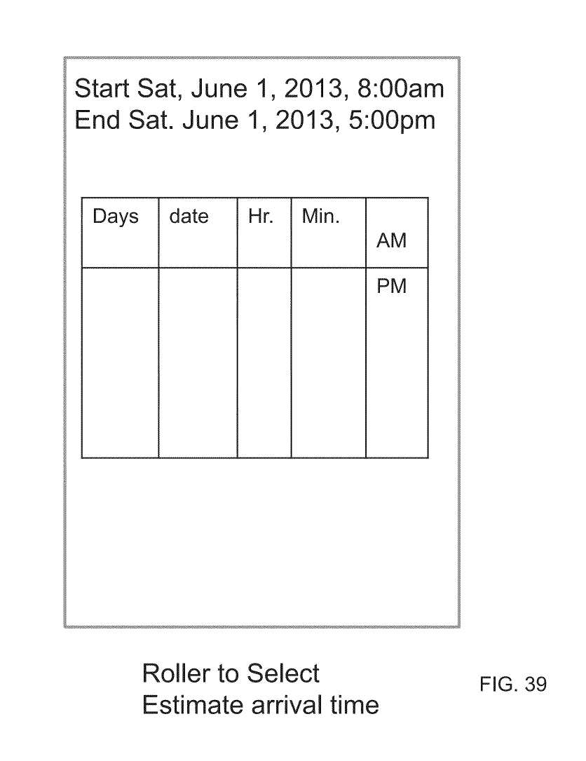

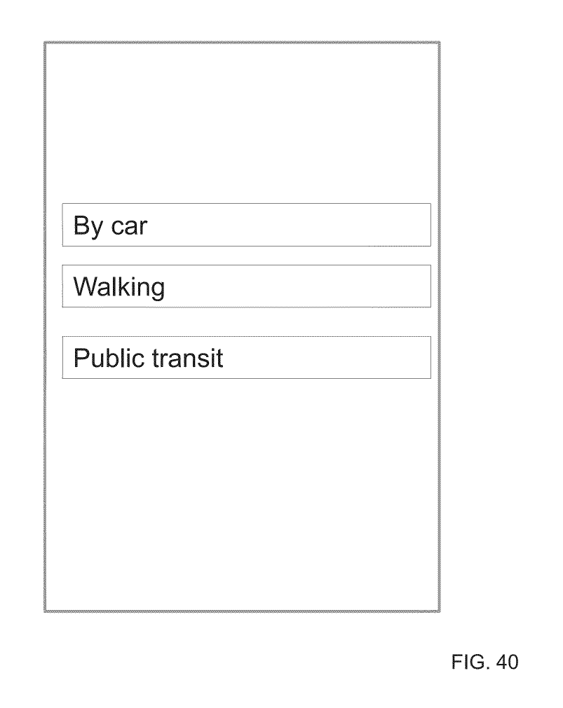

FIG. 37 illustrates an interface showing available assignment(s) for the personnel's review. In some embodiments, the interface can show one or more of (A) the name and location of the assignment, (B) the date and time of the assignment, (C) the estimated travel time to the work place, and (D) the hourly rate that the client is willing to pay the candidate personnel pre-taxed. In some cases, the personnel can select the name and location of the assignment, and the application can show a map of the location, as illustrated in FIG. 38 in accordance with some embodiments. In some cases, the personnel can select the date and time of the assignment, and the application can show a more detailed view of the time information, as illustrated in FIG. 39. In some cases, the personnel can select the estimated travel time icon so that the personnel can further adjust the arrival time to be communicated to the client. For example, the personnel can change the mode of transportation, as illustrated in FIG. 40, and the application can change the estimated travel time in response to the personnel's selection.

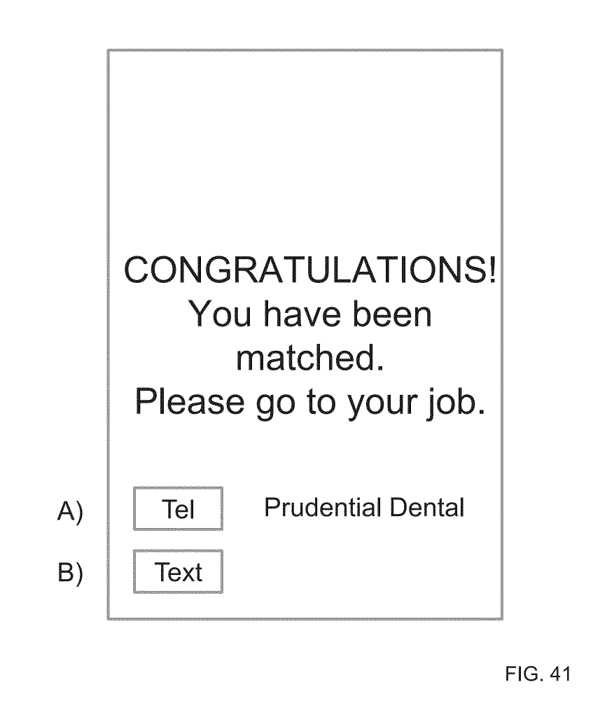

In some embodiments, the personnel can accept the assignment, reject the assignment, or make a counter offer by selecting the “interested?” icon. Once the personnel accepts the assignment, the personnel can wait to receive a confirmation from the server, indicating that the personnel has been selected for the assignment. FIG. 41 illustrates an interface for indicating that the personnel has been selected for the assignment in accordance with some embodiments. The interface can congratulate the personnel and provide the client's contact information with an option to text or call the client for further communication/instruction.

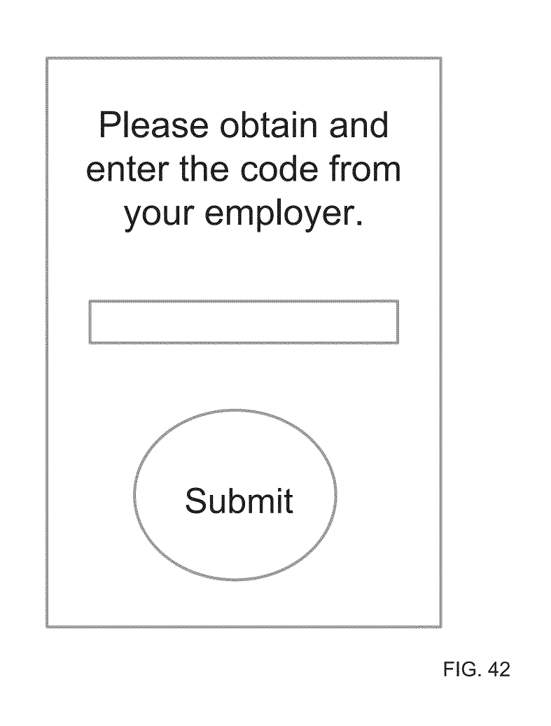

In some embodiments, as discussed above, the client might not be located at a place in which the assignment is to be performed, and the client can require the personnel to confirm the work commencement by scanning a scannable code. In some embodiments, the client can require the personnel to obtain a text code from the client and enter it into the application in order to confirm the work commencement, as illustrated in FIG. 42.

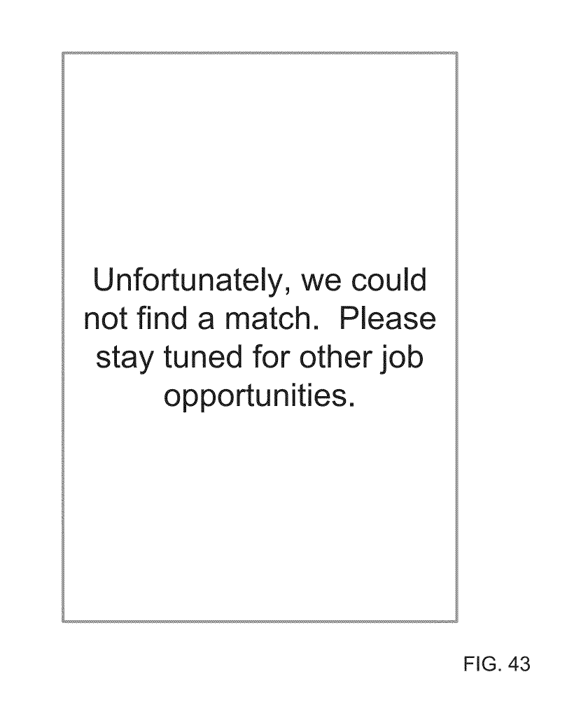

If the personnel is not selected for the assignment, the personnel would receive a notification indicating that the personnel was not selected. FIG. 43 illustrates an interface that notifies the personnel that the personnel was not selected. This interface can let the personnel know that no match was achieved and to standby for other job opportunities.

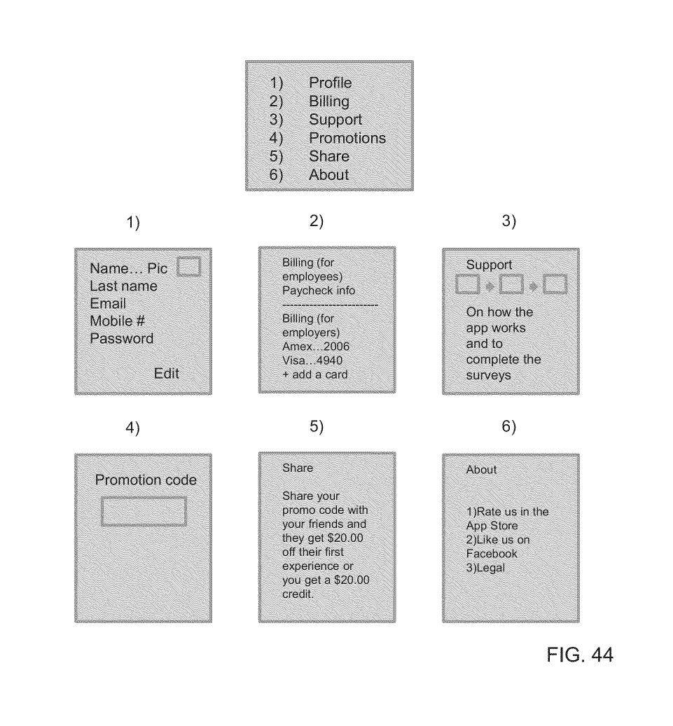

FIG. 44 illustrates a set of options supported by an application operating in the virtual staffing agency in accordance with some embodiments. The application can provide options for (1) setting a profile associated with a user (e.g., a client or a personnel), (2) setting billing information, (3) receiving support, (4) receiving promotions, (5) sharing information, and (6) receiving information about the application.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, can readily be utilized as a basis for the designing of other structures, methods, and systems for carrying out the several purposes of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter can be made without departing from the spirit and scope of the disclosed subject matter.

What is claimed is:

1. A method for providing a virtual staffing agency, comprising:
collecting attribute information via a first electronic device from at least one temporary personnel, wherein the attribute information is stored in a database on an application server;
receiving, at the application server, a request for a temporary personnel for a temporary job placement from a client via a second electronic device, wherein the temporary job placement is associated with temporary job criteria, wherein the temporary job criteria is stored in the database on the server;
generating, via a computer processor, a match between the temporary client and the at least one temporary personnel based on a comparison of the attribute information and the temporary job criteria stored in the database; and
notifying, via the first electronic device, the temporary personnel of the match.

2. The method of claim 1, further comprising:
receiving, via the computer processor, a notification of acceptance of the match from the temporary personnel; and
notifying, via the second electronic device, the temporary client of the accepted match.

3. The method of claim 2, further comprising:
receiving, at the application server, a notification of acceptance of the match from the temporary client; and
notifying, via the first electronic device, the temporary personnel of the accepted match.

4. The method of claim 3, wherein notifying the temporary personnel of the accepted match further comprises:
notifying, via the first electronic device, the temporary personnel of a date, time, and location of a temporary job associated with the accepted match.

5. The method of claim 4, further comprising:
receiving, at the application server, a current location of the temporary personnel from an automated determination of a location of the first electronic device;
generating, at the application server, a list of directions to a job site based on a current location of the temporary personnel; and
providing, via the first electronic device, the list of directions to the temporary personnel.

6. The method of claim 4, further comprising:
providing, via the first electronic device, a first code to a matched personnel to clock into the matched job; and
receiving, at the application server, a notification of an input at a computer terminal of the first code by the personnel.

7. The method of claim 6, further comprising:
providing, via the first electronic device, a second code to the matched personnel to clock out of the matched job.

8. The method of claim 1, wherein the attribute information comprises job certification data.

9. The method of claim 1, wherein the attribute information comprises at least a desired payment rate, dates of availability, and a date of birth.

10. The method of claim 6, wherein the attribute information further comprises a name, an email address, a home address, and a telephone number.

11. The method of claim 6, wherein the attribute information further comprises a license type and an associated skill set.

12. The method of claim 1, wherein the temporary job criteria comprises at least a distance preference, an employer name, and an employer address.

13. The method of claim 1, wherein generating the match between the temporary client and the at least one temporary personnel further comprises:
receiving, at the application server, a variance associated with the temporary job criteria, wherein the variance comprises a deviation from the temporary job criteria; and
matching, via the computer processor, the temporary client and the at least one temporary personnel if the attribute information is within the variance provided by the client associated with the temporary job criteria.

14. A computer system, comprising:
a processor coupled to a computer readable storage media and executing computer readable code which causes the computer system to perform operations including:
collecting attribute information via a first electronic device from at least one temporary personnel, wherein the attribute information is stored in a database on an application server;
receiving, at the application server, a request for a temporary personnel for a temporary job placement from a client via a second electronic device, wherein the temporary job placement is associated with temporary job criteria, wherein the temporary job criteria is stored in the database on the server;
generating, via a computer processor, a match between the temporary client and the at least one temporary personnel based on a comparison of the attribute information and the temporary job criteria stored in the database; and
notifying, via the first electronic device, the temporary personnel of the match.

15. The system of claim 14, wherein the code further causes the computer system to perform operations including:
receiving, via the computer processor, a notification of acceptance of the match from the temporary personnel; and
notifying, via the second electronic device, the temporary client of the accepted match.

16. The system of claim 15, wherein the code further causes the computer system to perform operations including:
receiving, at the application server, a notification of acceptance of the match from the temporary client; and
notifying, via the first electronic device, the temporary personnel of the accepted match.

17. The system of claim 16, wherein the code further causes the computer system to perform operations including:
notifying, via the first electronic device, the temporary personnel of a date, time, and location of a temporary job associated with the accepted match.

18. The system of claim 17, wherein the code further causes the computer system to perform operations including:
generating, at the application server, a list of directions to a job site based on a current location of a matched personnel; and
providing, via the first electronic device, the list of directions to the personnel.

19. The system of claim 17, wherein the code further causes the computer system to perform operations including:
providing, via the first electronic device, a first code to a matched personnel to clock into the matched job; and
receiving, at the application server, a notification of an input at a computer terminal of the first code by the personnel.

20. The system of claim 19, wherein the code further causes the computer system to perform operations including:
providing, via the first electronic device, a second code to the matched personnel to clock out of the matched job.

21. The system of claim 14, wherein generating the match between the temporary client and the at least one temporary personnel further comprises:
receiving, at the application server, a variance associated with the temporary job criteria, wherein the variance comprises a deviation from the temporary job criteria; and
matching, via the computer processor, the temporary client and the at least one temporary personnel if the attribute information is within the variance provided by the client associated with the temporary job criteria.

22. A computerized device for providing a virtual staffing agency having stored thereon computer executable instructions that, when executed by a computer system cause the computer system to perform a method comprising:
collecting, via a user interface, attribute information from at least one temporary personnel;
sending, to an application server, a request for a temporary job placement; and
receiving, from the application server, a notification of a match between the at least one temporary personnel and a temporary client based on a comparison of the attribute information and temporary job criteria stored in the database, wherein the temporary job placement is associated with temporary job criteria.

23. The device of claim 22, wherein the computer executable instructions further comprise instructions configured to cause the computerized device to perform a method comprising:
sending, to the application server, a notification of acceptance of the match from the at least one temporary personnel; and
notifying, via the user interface, the at least one temporary personnel of the accepted match.

24. The device of claim 23, wherein the computer executable instructions further comprise instructions configured to cause the computerized device to perform a method comprising:
notifying, via the user interface, the at least one temporary personnel of a date, time, and location of a temporary job associated with the accepted match.
